(19) United States
(12) Patent Application Publication
(10) Pub. No.: US 2012/0164738 A1
(43) Pub. Date: Jun. 28, 2012

(54) DETECTION OF SMALL LIGANDS WITH METMYOGLOBIN

(75) Inventors: James B. Kelly, Fredericksburg, VA (US); Fred M. Hawkridge, Powhatan, VA (US); Steven I. Baskin, Bel Air, MD (US); Matthew G. Clark, Middletown, MD (US); Scott Willens, White Marsh, MD (US)

(73) Assignee: U.S. ARMY MEDICAL RESEARCH AND MATERIEL COMMAND, Frederick, MD (US)

(21) Appl. No.: 12/115,460

(22) Filed: May 5, 2008

Related U.S. Application Data
(60) Provisional application No. 60/928,675, filed on May 3, 2007.

(51) Int. Cl. G01N 21/78; B01L 3/00

(52) U.S. Cl. 436/72; 436/109; 436/134; 436/98; 436/119; 436/103; 436/106; 436/124; 422/430

(57) ABSTRACT

The invention relates to methods and compositions for the rapid detection of small ligands, such as cyanide, carbon monoxide or azide, in small quantities. Specifically, metmyoglobin is used to bind small ligands which yield a product with a characteristic absorbance spectrum that is detectable and quantifiable. Also disclosed is a kit for detecting small ligands with metmyoglobin, which is portable and provides for practice of the invention without the use of harsh solvents or chemical reagents.

### RELATED APPLICATIONS

This application relates to and claims priority to U.S. Provisional Patent Application No. 60/926,675, which was filed May 3, 2007 and is incorporated herein by reference in its entirety.

### FEDERALLY SPONSORED RESEARCH OR DEVELOPMENT

The invention was made with government support under U.S. Army contract DAAD19-02-D-0001-0574. The government may have certain rights in the invention.

### FIELD OF THE INVENTION

The present invention relates to methods and compositions for the rapid detection of small ligands, such as cyanide, carbon monoxide or azide, in small quantities. Specifically, the invention combines metmyoglobin with a small ligand to yield a product with a detectable, characteristic absorbance.

### BACKGROUND OF THE INVENTION

Historically, cyanide has been used as a weapon to attack soldiers. It also causes civilian deaths due to fires, poisonings, and industrial accidents. Cyanide compounds are commercially available due to the many industrial processes that utilize cyanide or create a cyanide byproduct. The lethality of cyanide is pronounced in continued or closed spaces, such as combat support hospitals, dining halls, gyms, etc., where cyanide compounds could quickly deliver lethal effects. Additionally, cyanide poisoning is often difficult to distinguish from carbon monoxide poisoning, which can result in misdiagnosis and improper treatment. For these reasons quick detection is critical. But, the detection of cyanide is often difficult, especially in hot climates.

A procedure based on the deposition of cytochrome c oxidase (CCO), the purported primary target of cyanide, onto an electrode (see Cullison, et al., 1994, Burgess, et al., 1997, 1998), was used for detecting and analyzing cyanide, cyanide metabolites, and antidotes. Initially this procedure involved depositing a submonolayer of octadecyl mercaptan (OM) on gold electrodes (Cullison, et al., 1994). The OM molecule provided hydrophobic interactions with the hydrophobic regions of lipids and CCO and resulted in a fairly stable bilayer membrane. Adding a silver deposition step improved reproducibility of the OM deposition and the lipid bilayer formation. While this electrode based procedure proved suitable for the laboratory, it is less than ideal for field use. There is a present need for improved, non-hazardous, simple, lightweight, rapid detection methods. In particular, it is desired that better portable detection methods are developed so that exposure, or potential exposure, in the field can be quickly identified and proper medical treatment can be obtained. Preferably, the method does not require expensive or technically sophisticated equipment, is simple enough that special training is not required to use it, and the method quickly ascertains the presence of cyanide even when cyanide is present in only minute quantities.

### SUMMARY OF THE INVENTION

The invention provides simple and effective methods and compositions for detecting cyanide, or other small ligands, in minute quantities. The invention does not require large, expensive, technically sophisticated equipment or special training to perform or to interpret the results.

The invention provides methods of detecting a small ligand by contacting it with metmyoglobin such that the small ligand binds to the heme iron in metmyoglobin. The characteristic absorbance (ABS) spectrum for the heme iron in metmyoglobin will depend on the ligand species bound to the heme. This absorbance is detectable, even when only minute quantities of the product is present. Further, the detected ABS of the product correlates to the presence of the small ligand and can be used to quantify the amount of the small ligand that is present. Thus, the invention can be used to determine the presence of a small ligand and whether there is sufficient quantity of the ligand present to cause a safety concern.

While any small ligand that binds to a heme iron and has a characteristic, wavelength absorbance spectrum when bound to the heme iron is expected to be detected, preferred small ligands include cyanide, carbon monoxide, porphyrin, carbon disulfide, silane, phosphoric anhydride, imidazole, thiocyanate, azide, halogens or halides such as boride, fluoride, iodide, chloride, and astatide, and combinations thereof.

The invention provides flexibility in that metmyoglobin either may be in an aqueous solution, or attached, or incorporated, into a solid surface. In all cases, metmyoglobin is available at a high enough concentration that sufficient material is available for binding most or all of the small ligand present in a sample. Those of skill in the art of spectrophotometry will recognize that testing serial dilutions of a sample containing, or suspected of containing a small ligand, may be desirable to obtain accurate quantification of the small ligand and confirm results.

Where the metmyoglobin is attached to a solid surface, the attached metmyoglobin may be stored outside of an aqueous solution. When detection is desired, the attached metmyoglobin may then be exposed to an aqueous solution containing, or suspected to contain, a small ligand. While any solid surface to which metmyoglobin can attach such that its heme iron is available for binding to the ligand is likely a suitable surface, preferred solid surfaces include metallic nanoparticles, nonmetallic nanoparticles, electrodes, metals, cellulose, polymer products (e.g. test strips), glass, or combinations thereof.

Samples containing small ligands may be either biological or nonbiological in origin. Nonbiological samples include air, water, soil, combinations thereof, or any other material that can be combined with metmyoglobin in the presence of an aqueous solution. Biological samples include any biological fluid (e.g. blood, urine, sweat, etc.). Those of skill in the art will recognize that because light absorbance can be detected through a relatively thin layer of tissue, detection of a small ligand in a biological fluid does not necessarily require removal of the biological fluid from the individual. For example, detection may occur at a pulse point near the surface of the skin. This latter noninvasive embodiment has preferred applications in a variety of situations such as the field, where needles are objected to or impractical, or in screenings of large numbers of either animals or humans.

Absorbance may be measured through a variety of devices already familiar in the spectrophotometric arts. Such devices include spectrometers, colorimeters, test strips, dot blots, color reference charts or keys, and combinations thereof. A preferred device is a portable colorimeter. Output from a colorimeter may be sent to a chart recorder, data logger, computer, or similar device designed for data retention.

The methods of the invention are quite sensitive. For example, small ligands in concentrations ranging from less than 1 part per billion, to 10 parts per billion, to 100 parts per billion or more may be detected by the invention. Where the concentration of the small ligand is sufficiently high, color changes are visible. But, for greater accuracy, especially at very low concentrations, absorbance is preferably measured using a colorimeter or other spectrophotometric device. Those of skill in the art will be familiar with the variety of devices commercially available today.

The invention also provides for kits to detect small ligands with metmyoglobin. These kits comprise metmyoglobin, either in aqueous solution and/or bound to a solid surface; a container suitable for combining metmyoglobin and a sample suspected of containing a small ligand; and a device for measuring the absorbance of the wavelength of light of the bound small ligand/metmyoglobin product. Optionally, kits may include an aqueous solution suitable for combining metmyoglobin and a sample, or material that may be combined with water to make a suitable aqueous solution. Those of skill in the art will be familiar with making buffered, basic, or acidic solutions.

Suitable containers for combining metmyoglobin and a small ligand include any relatively small container in which a small ligand and metmyoglobin may be combined in an aqueous solution such that a device may detect the absorbance of the ligand/metmyoglobin product through the container, or a device may be inserted into the container to detect the absorbance. Preferred containers include cuvettes, vacutubes, test tubes, glass or plastic tubes, or small beakers or cups.

Other objects, features, and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 shows the rate of octadecyl mercaptan (OM) deposition with characterization of the electrode surface with cyclic voltammetry in 0.1 M Phosphate buffer, pH 7.4 after the silver deposition step. Results of electrode 12 are in black; of electrode 14 in dark gray, and of electrode 15 in light gray.

FIG. 2 shows the rate of octadecyl mercaptan deposition without characterization of the electrode surface with cyclic voltammetry in 0.1 M phosphate buffer, pH 7.4 after the silver deposition step. Results of electrode 23 are in dark gray, of electrode 24 in light gray, and of electrode 25 in black.

FIG. 3 compares the frequency change to deposition time of octadecyl mercaptan on the electrode surface.

FIG. 4 illustrates contamination in the cyclic voltammetry scans of the CCO electrode with two different electrodes (FIGS. 4A and 4B respectively). In FIG. 4A results for CCO electrode 12 CV1 are in black and show no peaks; for CCO electrode 12 CV2 are in dark gray and peak at a current between 1.00E-05 and 2.00E-05; for CCO electrode 12 CV3 are in light gray and peak at a current between 2.00E-05 and 3.00E-05; and CCO electrode 12 CV4 are in very light gray and peak at a current between 4.00E-05 and 5.00-E5. In FIG. 4B results for CCO electrode 19 CV1 are in black and peak at a current between 2.00E-05 and 4.00-E5; for CCO electrode 19 CV2 are in dark gray and peak at a current between 6.00E-05 and 8.000E-05; for CCO electrode 19 CV3 are in light gray and peak at a current between 4.00E-05 and 6.00E-05; for CCO electrode 19 CV5 are in light gray and peak at a current between 0.00E-05 and 2.00E-05; and results for CCO electrode 19 CV53 are in dark gray and peak at a current between 4.00E-05 and 6.00E-05.

FIG. 5 illustrates the determination of interfering peaks in cyclic voltammograms of a lipid only electrode. FIG. 5A illustrates that either the lipids were highly contaminated or chloride from the reference electrode reacted with the silver monolayer of the electrode. Results for CV1 are in black, peaking at 2.00E-05; for CV2 results are in dark gray, peaking between 2.00E-05 and 4.00E-05; for CV3 results are in gray, peaking just below 4.00E-05; and for CV3 results are in light gray, peaking above 4.00E-05. FIG. 5B illustrates the resulting cyclic voltammogram when a double junction electrode was used. Results for CV6 (light gray) are superimposed on the respective results for CV4 (upper curve) and CV5 (lower curve). FIG. 5C illustrates the interfering silver chloride peaks that occur in the presence of a single reference electrode when the double junction reference electrode was removed. Results for CV7 are in black. Results for CV8 are in gray. FIG. 5D illustrates the surface characterization of the electrode surface before the addition of lipid or lipid and enzyme. Results for a gold surface is in black; for a silver surface in dark gray; and for a OM surface in light gray. FIG. 5E compares a cyclic voltammogram from CV6 (very light gray), a lipid only electrode (see FIG. 5B), to these surface characterizations: gold surface (black), silver surface (dark gray), OM surface (light gray). The results for CV6 are superimposed on the results for OM surface. FIG. 5F is a combination of cyclic voltammograms from FIGS. 5A-5E for current scale comparison. Results for gold surface, silver surface, OM surface and CV6 are essentially superimposed on each other. In comparison, the results for CV4 show distinguishable peaks and valleys (dotted line).

FIG. 6 shows the characterization of a lipid only electrode with a double junction reference electrode and a filling single reference electrode filled with 0.1 M PB, pH 7.4 phosphate buffer during bilayer formation. FIG. 6A shows the lack of silver chloride interference peaks. Results for blank2 CV1 (black); for blank2 CV2 in gray (on top of results for blank2 CV1). FIG. 6B compares the double layer capacitance of the lipid bilayer and the double layer capacitance of the initial electrode surface characterizations. Results shown for gold surface (black), silver surface (dark gray), OM surface (thick light gray), and blank2 CV2 (thin light gray).

FIG. 7. FIG. 7A shows cyclic voltammograms of CCO when a double junction reference electrode is used and 1 M KCl is left out of the reference electrode during the enzyme/bilayer formation. Results shown for CCO CV1 (black), CCO CV2 (dark gray), and CCO CV3 (light gray). FIG. 7B compares the data of the lipid only electrode and CCO electrode. Results shown for CCO CV3 (black) and blank2 CV2 (gray).

FIG. 8 shows the effects on metmyoglobin (Mb(III)H₂O) in samples preserved with different concentrations of sodium hydroxide (NaOH). Results shown for pH 7.12 (diamond, ♦), for pH 7.52 (square, ▪, peak about 0.45 ABS), for pH 9.30 (triangle, ▴) and for pH 11.59 (square, ▪, peak about 0.25 ABS).

FIG. 9 provides the titration results for 5 ppm CN⁻ in 0.01 M NaOH with 2.5 ml of Mb(III)H₂O dissolved in 0.1M, pH 7.4 phosphate buffer.

FIGS. 10A and 10B are the respective absorbance plots from two separate experiments to determine the molar absorptivity of Mb(III)CN⁻ at 409 nm. Results for Mb(III)H₂O in black diamond (♦), and results for Mb(III)CN⁻ in gray squares (▪) in both FIGS. 10A and 10B.

FIGS. 11A and 11B are the respective results for detecting cyanide in well water using metmyoglobin in two experiments.

FIG. 12 shows the detection of cyanide with metmyoglobin. FIG. 12A shows the absorbance detected over time for the respective cyanide concentrations of 0.01 ppm (uppermost curve, highest ABS values), 0.05 ppm (second uppermost curve), 0.1 ppm (third uppermost curve) and 0.02 ppm (lowest curve, lowest ABS values). FIG. 12B correlates changes in cyanide concentration with changes in metmyoglobin concentration.

### DETAILED DESCRIPTION

The invention provides compositions and analytical procedures for the detection of free cyanide, or other small ligands, using metmyoglobin.

A. Detecting Small Ligands with Metmyoglobin

Myoglobin is a small heme protein (MW 17,800) found primarily in cardiac and skeletal muscle that is used to store dioxygen and to assist in the delivery of dioxygen to the mitochondria. Myoglobin with its heme iron in the tertiary (+3) state is known as metmyoglobin (Mb(III)H₂O) or aquomyoglobin since water is bound as the sixth ligand. When dissolved in water or phosphate buffer without further preparation, myoglobin exists primarily as Mb(III)H₂O and has a relatively long shelf-life at room temperatures. Small ligands (SLs) can displace the bound water molecule of metmyoglobin and bind to the heme iron to form Mb(III)SL⁻ as follows:

Mb(III)H₂O+SL⁻ [symbol] Mb(III)SL⁻+H₂O

Advantageously, the bound product, Mb(III)SL⁻, has a characteristic absorbance spectrum that differs from the absorbance spectrum of either metmyoglobin or the unbound small ligand. The inventors found that by using the methods of the invention described herein, these characteristic absorbance spectra may be used to detect the presence of various small ligands even when the bound product is present in very low concentrations. These absorbance spectra are preferably, but not limited, to the visible region (400-700 nm) of light.

For example, where the small ligand is cyanide (CN⁻) cyanometmyoglobin (Mb(III)CN⁻) will form in the presence of metmyoglobin. When cyanometmyoglobin is formed, a bright, visible, color change is observed. Using Beer's law in the difference form, the inventors demonstrated that this color change can be reliably measured, even at low levels, and is proportional to the concentration of the bound product.

Other suitable small ligands of interest include carbon monoxide, porphyrin, carbon disulfide, silane, phosphoric anhydride, imidazole, thiocyanate, azide, halogens or halides such as boride, fluoride, iodide, chloride, and astatide, and combinations thereof. These small ligands will displace the bound water molecule of metmyoglobin and a characteristic absorbance spectrum (i.e. color change) will be exhibited. This color change will be measurable and proportional to the concentration of the bound product Mb(III)SL⁻. Further, because the absorbance spectrum of each different Mb(III)SL⁻ relates to a specific small ligand, the invention may usefully indicate the presence of multiple small ligands in a single sample. Depending upon the specific detection device or instrumentation, individual spectra may be detected one at a time or multiple spectra may be detected simultaneously. For example, a colorimeter is more suited to detecting one absorbance spectrum at a time. In contrast, a test strip or dot blot may detect multiple absorbance spectra (i.e. multiple colors occur) at a time, or alternatively, a test strip may be used in combination with a black light to detect absorbance spectra across the visible and ultraviolet regions of light.

If multiple ligands or other materials are present and interference occurs, it may be advisable to separate the object small ligand before testing from the remainder of the sample. Micro diffusion cells and the like may be used to eliminate such interferences. Alternatively, a micro diffusion cell containing Mb(III)H₂O may be used to both separate the small ligand from interfering material and detect the small ligand.

B. Advantages Over the Art

The invention provides numerous advantages over the present art. For example, the invention may be used in the laboratory or field by inexperienced or non-technical personnel, complex or bulky equipment are not required, and toxic and/or carcinogenic hazards associated with present technologies are reduced or eliminated. Metmyoglobin is not toxic to humans, animals, plants. As such, the invention is environmentally friendly and accidental spills will have little or no impact on the ground or in waterways.

Large quantities of sample and myoglobin are not needed. Furthermore, the use of unstable reagents can be avoided. For example, some spectrophotometric methods use heat and light sensitive reagents, making them unsuitable or difficult to use in a field setting. In contrast, metmyoglobin is stable in light and at a range of temperatures, including room and body temperatures. Further, metmyoglobin is easy to prepare and store. For example, when myoglobin is dissolved in water or 0.1 M phosphate buffer, pH 7.4 myoglobin exists primarily as Mb(III)H₂O, and without further preparation and can be stored for long periods of time at room temperature. Myoglobin can be purchased easily and is relatively inexpensively. Metmyoglobin can be used in diffusion cells or incorporated into nanoparticles.

The invention is very sensitive with near perfect calibration correlation coefficients (see Examples). For example, the detection limit using the Cary 50 spectrophotometer was approximately 10 parts per billion. By using a more sensitive spectrophotometer lower detection limits can be reached—i.e. 1 part per billion or even 100, 10, or 1 parts per trillion. Color change is immediate without heating or adding additional reagents.

Further advantages of the invention are that it is very simple and easy to understand. It can be easily adapted to miniaturization (e.g. test strips). The use of lightweight, portable detection devices are preferred. The invention can be used to test in biological media, as well as non-biological media, such as air, water, soil, or other media that is compatible with aqueous solutions.

C. Kits for Detecting Small Ligands

The invention provides for a variety of kit compositions. It is preferred, but not required, that the kit is portable. A kit may be designed to detect one or more pre-determined small ligands. For example, a kit may be designed to detect only cyanide, to detect cyanide and carbon monooxide, or to detect cyanide and azide. Alternatively, the kit may allow the user the flexibility to select from a variety of small ligands. Preferred small ligands include, but are not necessarily limited to, cyanide, carbon monoxide, porphyrin, carbon disulfide, silane, phosphoric anhydride, imidazole, thiocyanate, azide, halogens or halides such as boride, fluoride, iodide, chloride, and astatide, and combinations thereof. The essential characteristics of the selected small ligand are that (1) it readily displaces the water molecule in metmyoglobin to bind the heme molecule and (2) the bound small ligand/metmyoglobin product has a detectable, characteristic absorbance spectrum.

An exemplary kit is a portable or field colorimetric test kit for cyanide that may be used for either environmental (e.g., water, soil, airborne particles) or biological (e.g., blood, saliva or urine) detection of cyanide. Applications may include testing of: water or food in a hostile environment; an individual to a possible occupational exposure or incident in which poisoning is suspected; or detection of environmental hazards due to fire, natural disaster, or industrial accidents. Such kits may be useful for distinguishing between exposure or potential exposure to cyanide, azide, carbon monoxide, and/or other small ligands.

Another exemplary kit is a “hand-held” unit. For examples, soldiers may use a hand held device to test water or soil samples in remote locations, or biological samples, such as blood or urine for field exposure. Firefighters may use a hand held device to ascertain exposure to specific toxins. In this latter instance, the user may desire to detect the presence of any of a group of toxins but not need to discern which specific small ligand is detected. It is envisioned that hand held or portable kits will be capable of detecting multiple small ligands either together or separately. Optionally, a handheld unit may contain a mixing chamber, separation chamber, or a battery operated spectrophotometric device.

Another exemplary kit may include a simple test strip whereby metmyoglobin is immobilized to a solid support. The test strip may be comprised of metal, polymers, cellulose, glass, plastic, gel, cloth, other synthetic materials, or combinations thereof. The strip may be stored in a dried or aqueous state. In use, the strip is immersed in the test solution, where if cyanide or another small ligand is present it will bind to the metmyoglobin on the test strip and result in a color change. Preferably, the amount of metmyoglobin immobilized to the test strip is such that the color change will be visible to the human eye. The test strip may then be compared to a color intensity reference chart where color intensities have been calibrated to correspond to specific amounts of cyanide or other small ligand. Alternatively, a colorimetric or spectrometric device may be used to ascertain the color change and/or the specific absorbance spectrum.

When bound to different small ligands, metmyoglobin will have different absorbance spectra that are distinguishable and measurable. Preferably, these distinct ABS spectra are in the visible range, and color changes are specific to particular small ligands; however, any detectable color or ABS spectrum change is sufficient to discern the presence of a small ligand. For example, a test strip with bound ligands may be compared to a color spectrum chart which has been calibrated to the corresponding small ligands bound to metmyoglobin. Matching the color and intensity of the test strip to the reference chart will identify the specific small ligand toxin as well as the amount so that the appropriate course of action may be taken.

Although it is envisioned that samples may be measured directly, under some instances some sample preparation may be necessary or desired. By way of example, samples containing contaminating or interfering substances may be subjected to partial purification. Molecular size exclusion methods, i.e., dialysis, may be used to separate low molecular weight cyanide or small ligands from larger contaminating molecules. Optionally, molecular size exclusion may be incorporated into a kit in the form of a diffusion chamber. Another type of sample preparation may include the separation of the aqueous or hydrophilic phases from hydrophobic phases in complex or crude samples.

Other embodiments also include attaching metmyoglobin to solid substrates either internally or externally such that the heme molecule is available for binding to the small ligand. Exemplary solid surfaces include nanoparticles (either metallic or nonmetallic), electrodes, metals, glass, polymers, cellulose, plastic, gel, other synthetic materials, or combinations thereof for the detection of cyanide or other small ligands.

For example, an electrode may be coated with a thin layer of metmyoglobin, and a protective membrane may also be present. Alternatively, metmyoglobin may be incorporated into either metallic or nonmetallic nanoparticles using known technology. Those of skill in the art will be familiar with cellulose based (i.e. paper) or plastic test strips that change color in the presence of the certain molecules. These colorimetric test strips may incorporate a color reference key or a color reference chart may be separate from the test strips.

D. Cytochrome c Oxidase and Cyanide

Cytochrome c oxidase (CCO) is the terminal enzyme in the mitochondrial oxidative phosphorylation chain and a crucial enzyme for aerobic respiration. The catalytic core of bovine CCO is composed of subunits I, II and III, which are mitochondrially encoded. Bovine CCO redox activity stems from four redox centers that reside in subunits I and II: two iron centers, heme α and heme α₃, and two copper centers, Cu_{A} and Cu_{B}. Subunit I contains three of these redox centers: the low spin heme α and the high spin heme α₃-Cu_{B} (the dioxygen binding site). Subunit II of CCO, located on the cytosolic side, contains the binuclear Cu_{A} center, receives its electrons from solution resident cytochrome c via binding to the subunit II and transfers the electrons to heme α and finally to the dioxygen binding site as shown in the following formula:

Cytochrome c²⁺→Cu_{A}→/heme α→/heme a₃/Cu_{B} site→O₂

Cytochrome c oxidase catalyzes the reduction of dioxygen to two waters via the following overall reaction: 4 Cytochrome c²⁺+4 H⁺+O₂→4 Cytochrome c³⁺+2 H₂O. This exergonic reaction liberates free energy that is used to pump protons across energy-transducing membranes, creating an electrochemical gradient that is used in the production of ATP. The exact mechanism by which dioxygen is reduced to water and whether the mechanism is sequential or branched are not known.

It is believed that the primary reason for the toxicity of cyanide is the inhibition of CCO activity. Cyanide blocks CCO's ability to reduce oxygen to water, which terminates the production of adenosine triphosphate (ATP) at that step. The high spin heme α₃/Cu_{B} in CCO is the redox center that is thought to be responsible for cyanide binding as well as for binding to a variety of other inhibitor ligands such as nitric oxide and carbon monoxide. Many publications have addressed the inhibition of CCO by cyanide; however, there are still inconsistencies in the literature as to the exact mechanism.

There are other biochemical processes affected by cyanide, and there is recent evidence that the cyanide metabolite 2-aminothiazoline-4-carboxylic acid (ATCA) is also toxic. ATCA is a minor cyanide metabolite that is formed by combination with free cystine during cyanide intoxification, and its metabolism increases as cyanide concentrations increase. Production of ATCA is found predominately in organs of the body where rhodanese levels are low, such as the brain and heart, and has been found to be a neurotoxicant, forming hippocampal CA1 lesions in rodents. Large amounts of CCO are also found in the heart; however, no published literature to date has thoroughly examined the effects, if any, of ATCA on CCO.

E. CCO Modified Electrodes for Detecting Small Ligands

Cytochrome c oxidase was immobilized into an electrode supported lipid bilayer membrane (LBM). This modified CCO electrode closely mimics the in vivo behavior of CCO and its in vivo environment in the inner mitochondrial membrane. It provides a uniform distribution of enzyme orientations such that the oxygen reduction site faces the electrode surface, and the oxidation site for cytochrome c protrudes into solution. The thin immobilization matrix has a membrane thickness of about 5 nm to about 50 Å. This matrix maintains the enzyme in active form, protects against thermal and chemical degradation, prevents enzyme leaching, and helps to eliminate problems caused by substrate/analyte diffusion through common immobilization matrices, which are usually about 1μ or 10,000 Å thick. The inventors are unaware of any other enzyme-modified electrodes in the art having this thin structure and its advantages.

The inventors isolated bovine CCO according to the Soulimane and Buse Triton X-100 preparation (Soulimane and Buse, 1995). Cytochrome c oxidase was then incorporated into a lipid bilayer membrane on a quartz crystal gold electrode using a procedure developed for reconstituting CCO into vesicles in solution involving cholate dialysis (Hinkle et al., 1992). The Soulimane and Buse isolation procedure for CCO was selected because this preparation produces maximal turnover numbers, kₘₐₓ≧600 s⁻¹, which is similar to the maximum activity of CCO in the mitochondrial membrane.

The phospholipids/isolated dimer contents in the Triton X-100 preparation are similar to the in vivo contents and contained phosphatidylethanolamine, phosphatidylcholine and cardiolipin as the major constituents. This lipid content is relevant since it has been suggested by others that CCO activity depends on the hydrocarbon environment of the membrane (usually favored by C18:1 unsaturated hydrocarbon tails) and that cardiolipin is essential for maximal CCO activity. Previously it was found that the crystal structure of bovine heart CCO revealed 3 different polypeptide subunits with a calculated monomer molecular mass of 204,005 kD (see Tsukihara, et al., 1995, 1996). Located within the subunits were two hemes, three coppers, one magnesium, and one zinc atom, and located at the surface were eight lipids (five phosphatidyl ethanolamines, three phosphatidylglycerols) and two cholates. Cardiolipin was not detected in the x-ray crystallography method, but the intermonomer space was not examined and may contain room for several cardiolipins.

Using SDS/page, Soulimane and Buse demonstrated that the isolation technique revealed CCO to have 13 polypeptide subunits in agreement with the known literature (Soulimane and Buse, 1995). Bovine CCO normally exists as a dimer, and microscopy techniques have suggested an asymmetrical distribution in the inner mitochondrial membrane. Depending on the microscopy technique used CCO protrudes as much as 60-80 Å on the cytosolic side and very little on the matrix surface side, about 10-20 Å. Taniguchi determined that the gold crystal surface was not atomically smooth and had valleys 50 Å deep and peak to peak distances of 300 Å, which gives enough room for the matrix side of immobilized CCO and provides room for a thin layer of trapped water molecules between the bilayer and the metal surface.

F. Henry's Gas Law Constant for Cyanide

Since cyanide has a pKa of 9.2, samples with a pH lower than 9.2 tend to lose cyanide as hydrogen cyanide to the atmosphere. Henry's Law describes the solubility of a gas in water under dilute conditions and low pressure, and the general form of Henry's Law is written as:

$${k}_{H} = \frac{{c}_{a}}{Pg}$$

where c_{α} is the concentration of a species in the aqueous phase and P_{g} is the partial pressure of that species in the gas phase. Henry's law shows that the concentration of a solute gas in a solution is directly proportional to the partial pressure of that gas above the solution at equilibrium. Henry's law may also be expressed as a function of temperature as follows:

$${k}_{H} = {k}_{H}^{θ} \cdot {exp}^{( \frac{- {Δ}_{soln}^{H}}{R} ( \frac{1}{T} - \frac{1}{{T}^{θ}} ) )}$$

where, ΔₛₒₗₙH is the enthalpy of solution, T^{θ} is standard condition temperature (298.15 K) and the temperature dependence is given by

$\frac{- d ln {k}_{H}}{d ( \frac{1}{T} )} = \frac{{Δ}_{soln} H}{R} .$

| Cyanide Species | k_{H}^{θ} [units: M/atm] | $\frac{- d ln {k}_{H}}{d ( \frac{1}{T} )} [ \text{units:} K ]$ |
|---|---|---|
| CN | 8.0 x 10⁻² | 1400 |
| HCN | 9.3 | 5000 |
| | 1.2 x 10¹ | |
| | 7.5 | |

The values listed are from different references cited in Sanders compilation of Henry's gas law constants (Sanders, 1999).

### DEFINITIONS

Unless defined otherwise, all technical and scientific terms used herein have the same meaning as is commonly understood by one of skill in the art to which this invention belongs at the time of filing.

The term “small ligand” or “SL” as used herein refers to small molecules capable of replacing the water molecule in metmyoglobin and binding to the heme iron of metmyoglobin such that the resulting bound product has an absorbance spectrum characteristic of it and distinguishable from the absorbance spectra of either metmyoglobin or the unbound small ligand. Small ligands include, but are not limited to, cyanide, carbon monoxide, porphyrin, carbon disulfide, silane, phosphoric anhydride, imidazole, thiocyanate, azide, halogens or halides such as boride, fluoride, iodide, chloride, and astatide, and combinations thereof.

The term “biological fluid” as used herein refers to any fluid produced or excreted by any living organism, including but not limited to blood, serum, plasma, urine, semen, sweat, saliva, tears, mucus and other secretions, and combinations thereof. Biological fluids also include fluids derived from living organisms or from the aforementioned fluids including extracts, isolates, dialysates, eluates, purifications, fermentations, condensates and the like.

The term “nonbiological sample” as used herein refers to any sample including but not limited to environmental samples such as air, samples including dust, water (including drinking water), soil, scrapings or material wiped or washed from any surface, or particles which may be expected of being exposed to cyanide or another small ligand. Also included are fluids used to suspend samples removed by wiping with a solid substrate such as a paper, cloth, or sponge. Nonbiological sample also includes mixtures of two or more of these various substances.

The term “aqueous solution” as used herein refers to any solution comprising water. Aqueous solutions are capable of solubilizing substances which are hydrophillic and include, but are not limited to, salt solutions, strong or weak acids or bases, solutions of proteins, carbohydrates, or nucleic acids, and most biological solutions such as blood or urine.

The term “device”, as used herein, is broadly defined to include any instrumentation, of any type, that can be used to detect the absorbance change of the metmyoglobin-ligand species. Such devices include, but are not limited to, spectrophotometers, colorimeters, plastic test strips, paper test strips, dot blots, and the like. Optionally, a device may be a reference chart or key so that a user may identify a small ligand based on color and/or estimate the quantity of the small ligand based on color intensity.

A “reference chart” or “reference key” may be solid or liquid and include several differently colored liquids or solids that represent the results a user may expect in the presence of specific small ligands or quantities of small ligands.

### EXAMPLES

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Materials and Methods:

A. Equipment

Spectrophotometric measurements were obtained using a Varian Cary 50 (Palo Alto, Calif.). Solutions were prepared using ultra pure water that was purified using a Direct-Q3 system (Millipore Corporation, Billerica, Mass.) to exhibit a resistivity of 1.8.2 MΩ cm. The pH of the solutions was measured using a Corning model 440 pH meter (Woburn, Mass.).

B. Quartz Crystal Electrodes

Gold QCM electrodes (made to oscillate at 10 MHz) were purchased from International Crystal Manufactures Co. (Oklahoma City, Okla.) and consist of 1000 Å of vapor-deposited gold on polished quartz with a 50 Å chromium adhesion layer between the gold and quartz. The QCM electrodes geometric area is 0.2 cm². Prior to use, the gold QCM electrodes were first rinsed with absolute ethanol and then distilled dionized (DI) water, blown dry with research grade nitrogen and then placed in an ultraviolet light surface cleaner purchased from Novascan (Ames, Iowa). Ozone was generated for 5 minutes and then removed 55 minutes later by applying a vacuum through an ozone neutralizer attached to the ultraviolet light surface cleaner.

C. Silver Deposition

In earlier work approximately 1.6 monolayers of silver (1 mM AgNO₃ 99.999%, Sigma-Aldrich, St. Louis, Mo.) was electrochemically deposited onto the electrode surface using an asymmetric double potential step method (Burgess and Hawkridge, 1997). The Ag/AgCl, 1 M KCl reference electrode is isolated in a 1 mMAgNO₃ chamber to prevent AgCl deposits on the working electrode surface. An initial potential of +500 mV is applied to obtain a stable baseline and then stepped to +300 mV to initiate silver deposition. Both the current and frequency shift are monitored during deposition. The potential is stepped to approximately +400 mV to stop silver deposition. The in-house built potentiostat used in earlier work allowed potential control during the experiment. With CH Instrument's potentiostat, the user cannot control the potential during the experiment and is limited to initial parameter settings. Therefore several experiments have to be performed to duplicate the asymmetric double potential step. After depositing silver, the electrode first is tripled rinsed with Direct-Q purified water, then rinsed with ethanol, and then dried with research grade nitrogen in preparation for the octadecyl mercaptan deposition. Cyclic voltammograms from −100 mV to +300 mV may be obtained in phosphate buffer (0.1 M, pH 7.4) to characterize the deposited silver layer and to compare the double layer capacitance.

D. Octadecyl Mercaptan Deposition

Absolute ethanol (4 ml) is added to the cell, and research grade nitrogen is allowed to gently bubble in the ethanol through a stainless steel needle (22 gauge, blunt tip) placed about 2 mm below the surface. The electrodes are then allowed to equilibrate with the ethanol until a stable baseline frequency is observed. Once a stable baseline is achieved 50 μl of 500 μM OM will be added to the ethanol (giving an OM concentration of 6.25 μM) just below the nitrogen agitation. Approximately 24 ng of OM will be deposited onto the electrode surface with the aid of the QCM to monitor frequency changes of approximately 21 Hz giving approximately 0.5 monolayer coverage. This QCM frequency shift is used to determine when to remove the QCM electrodes from the reacting solution to control the OM coverage. The reaction is quenched by rinsing the cell with absolute ethanol and Direct-Q purified water. The average reaction time of 21 experiments, for a 0.5 monolayer of OM, was determined to be 10.64±4.42 minutes with the variations attributed to the gentle nitrogen bubbling (Burgess and Hawkridge, 1997).

E. Sauerbrey Equation

The correlation of frequency change and mass change as described by the Sauerbrey equation was investigated by Burgess and Hawkridge, 1997.

### In Sauerbrey Equation

$$Δ F = \frac{- 2 {f}_{o}^{2} Δ m}{{A ( {v}_{q} {ρ}_{q} )}^{1 / 2}}$$

$$\frac{2 {f}_{o}^{2}}{{A ( {v}_{q} {ρ}_{q} )}^{1 / 2}}$$

corresponds to the QCM sensitivity constant. It was determined that the QCM sensitivity constant calculated from silver deposition charge/frequency shift data (1.11 Hz/ng) is in good agreement with that predicted by the Sauerbrey equation (1.13 Hz/ng) and that the sensitivity constant was also independent of the silver deposition potential (see Sauerbrey, 1959; Bruckentein and Shay 1985; Burgess and Hawkridge, 1997). Based on the QCM sensitivity constant calculated from the silver deposition experiments, a 21 Hz shift in QCM, frequency corresponds to the formation of half of a monolayer of OM.

F. Preparing Lipid Solution

The lipids DOPE (1,2-Dioleoyl-sn-glycero-3-phosphoethanolamine—MW 744.04 (500 mg) 18:1 PE) and DOPC (1,2-Dioleoyl-sn-glycero-3-phosphocholine—MW 786.15 (500 mg) 18:1 PC) are obtained from Avanti Polar Lipids, (Alabaster, Ala.) in chloroform storage solvent. The lipid solution is prepared using 2.5 ml DOPE and 0.3 ml DOPC in a round bottom flask wrapped in aluminum foil to avoid photodegradation. The chloroform is removed from the DOPE and DOPC mixture using a stream of filtered research grade nitrogen. Fifty milligrams (50 mg) of sodium deoxycholate (Sigma-Aldrich, St. Louis, Mo.) is then added to the round-bottom flask with 3 ml of 0.1 M phosphate buffer, pH 7.4, and allowed to stir at 4° C. with agitation until the lipids are solubilized. The lipids are then treated with Chelex-100 (ion-exchange resin, BioRad, Hercules, Calif.) for about 12 hours at 4° C. with agitation to remove metal cation contaminants. The Chelex-100 is then removed by filtration (UNIFLO plus 0.2/mCA and glass fiber) from the deoxycholate-lipid solution. The final stock lipid solution is composed of 11 mM DOPE, 2 mM DOPC and 40 mM sodium deoxycholate and stored at −80° C.

G. Preparing the CCO Modified QCM Electrodes

Bovine CCO that was isolated using the Soulimane and Buse procedure by Dr. Bertha C. King. Dr. Zoia Nikolaeva, and Professor Mikhail Smirnov was obtained from Dr. Fred Hawkridge's group at Virginia Commonwealth University.

Bovine CCO is incorporated into a lipid bilayer membrane on the electrode surface by mixing equal volumes of a 2 mg/ml solution of CCO (solubilized in 1 mM Tris/HCl, pH 7.6, 0.1% Triton X-100) and a lipid solution composed of 11 mM DOPE, 2 mM DOPC and 40 mM sodium deoxycholate. The anionic detergent sodium deoxycholate is used in the dialysis procedure to solubilize the protein lipid mixture. The mixture is then injected into the sample chamber of a dual-chambered electrochemical dialysis cell to prepare the CCO lipid bilayer membrane on the electrode surface. The molecular porous membrane tubing with molecular weight cut off (MWCO) 3500 (Spectrum Laboratories, Rancho Dominguez, Calif.) was used as a dialysis membrane and is soaked in water to remove glycerin and sulfides from the membrane prior to use. Phosphate buffer (0.1 M, pH 7.4, ACS reagent grade) is then allowed to flow through the dialysis chamber of the cell for 18 hours at a flow rate of 25 μl/min. Then phosphate buffer (0.1 M, pH 7.4) is introduced to the sample chamber for approximately 20 hours at a flow rate of 5 μl/min to remove any excess sodium deoxycholate. Observation of a typical immobilized CCO voltammogram (i.e., large oxidative current as compared with lipid bilayer only electrode) indicates CCO activity and the endpoint of CCO and bilayer formation.

Cytochrome c (Sigma-Aldrich, St. Louis, Mo.) is reduced with sodium dithionite and desalted using a 5 ml high-trap size exclusion column (Amersham, Piscataway, N.J.). The concentration of reduced horse heart cytochrome c can be determined spectrophotometrically using a molar absorptivity (λₘₐₓ=550 nm) of 29,500 M⁻¹ cm⁻¹ (Gelder and Slater, 1962; Margoliash and Schejter, 1966).

### Example 1

### Detection with Cytochrome c Oxidase Modified Electrodes

A. QCM Reference Oscillator

As described in the Method and Materials above, the QCM is used in the preparation of the electrode surface before incorporation of CCO in a lipid bilayer on the electrode surface. Previous work used a QCM housed in a Faraday cage, built in-house based on the circuitry design published by Bruckenstein et al. and Shay, 1985; and Bruckenstein et al., 1994 and controlled using Lab View™ software (National Instruments, Austin, Tex.). A commercially equivalent QCM purchased from CH Instruments did not work initially. The operational failure of the QCM was found to be due to the 8 MHz reference oscillator in the electronics of the QCM and the use of 10 MHz electrode crystals. Several companies indicated that a 10.005 MHz oscillator crystal with the exact same output logic would require custom manufacturing, take several months to produce and would require bulk pricing. Therefore the programmable JITO-2 reference oscillator (Mouser electronics, Mansfield, Tex.) with a reference frequency of 10.005 MHz was considered since bulk shipment or custom pricing was not required and delivery time was estimated to be less than two weeks. CH Instruments was unable to specify whether the JITO-2 would work with their electronics due to the different output logics. The JITO-2 was ordered and appears to work well with the QCM electronic circuit.

B. Octadecyl Mercaptan (OM) Deposition

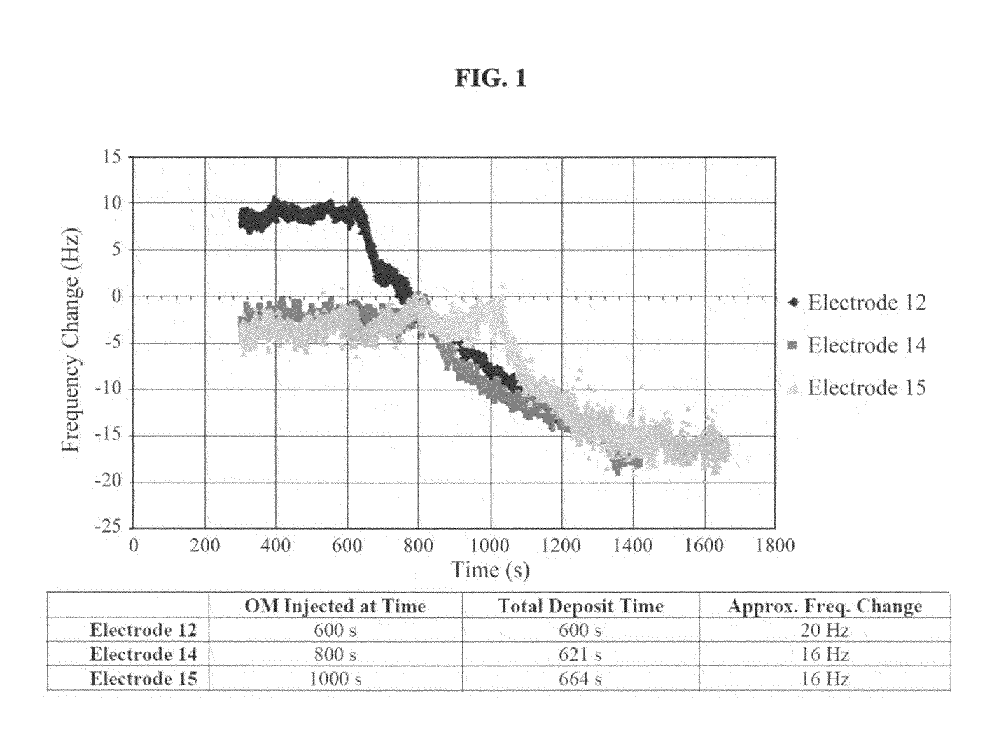

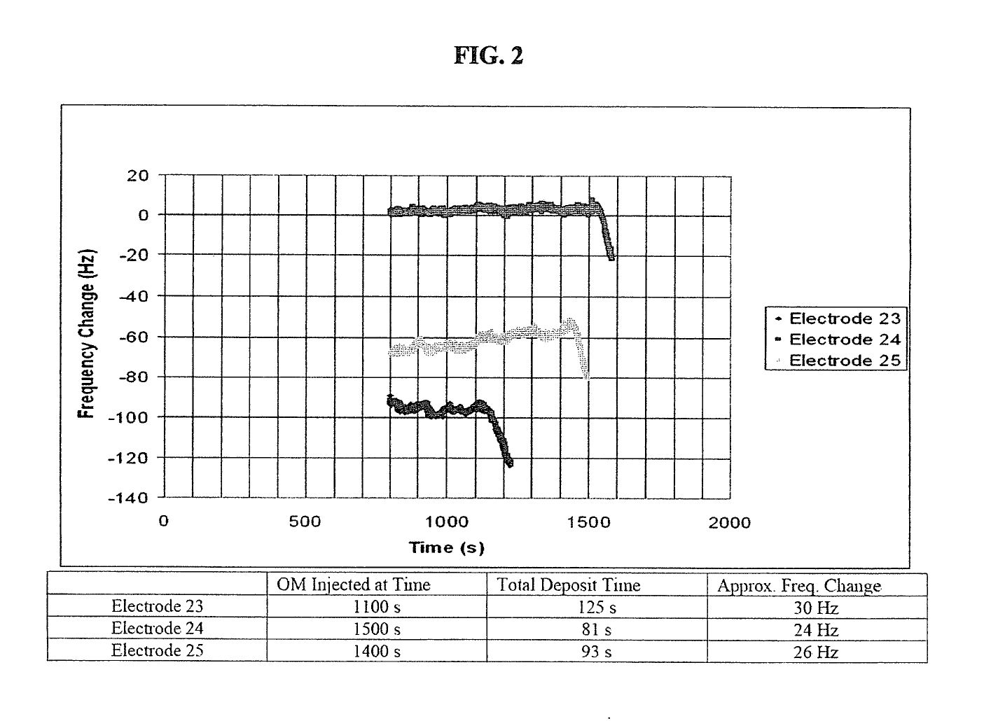

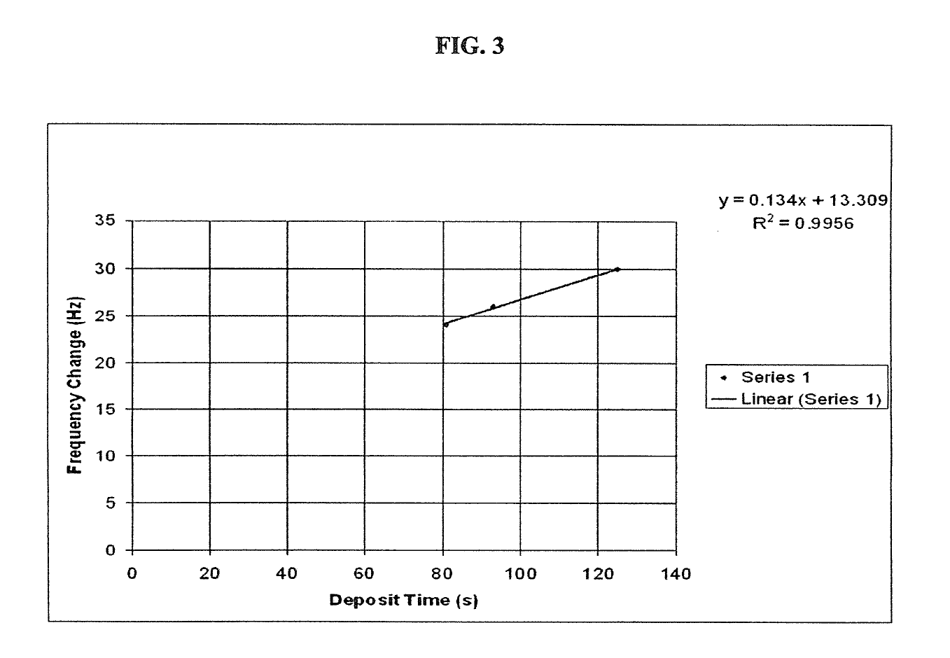

The deposition of OM is necessary to give a hydrophobic region above the electrode surface for interaction with the hydrophobic region of the lipid bilayer and enzyme, which results in a more stable bilayer. Initially, characterization of the silver surface using cyclic voltammetry in 0.1 M, pH 7.4, phosphate buffer was used to determine the extent of contamination of the electrode surface after silver deposition and as a reference for double layer capacitance changes for the OM deposition. For example the presence of current peaks in the potential window would likely indicate that silver chloride was formed during the silver deposition step. However, this surface characterization may have caused the electrode surface to be coated with phosphate anions, including PO₄³⁻, even though its concentration is extremely small (less than 10⁻¹²). When the surface is characterized with phosphate buffer the frequency change does not necessarily increase with deposition time and was found to take 10 minutes or so longer, which is in the published timeframe (FIG. 1). However, if the silver characterization step is left out, the OM deposition (˜21 Hz shift) occurs much faster and in less than two minutes (FIG. 2). In addition the frequency change was found to be linear with deposition time in this case (FIG. 3). Reproducibility also depends on other variables, and the flux of the OM to the surface will be affected by placement of the stainless steel needle, nitrogen agitation, ethanol equilibration time, temperature changes, and OM concentration. Precise control of these other variables will help enable the comparison of electrode surface effects.

C. Interference in Cyclic Voltammetry of CCO

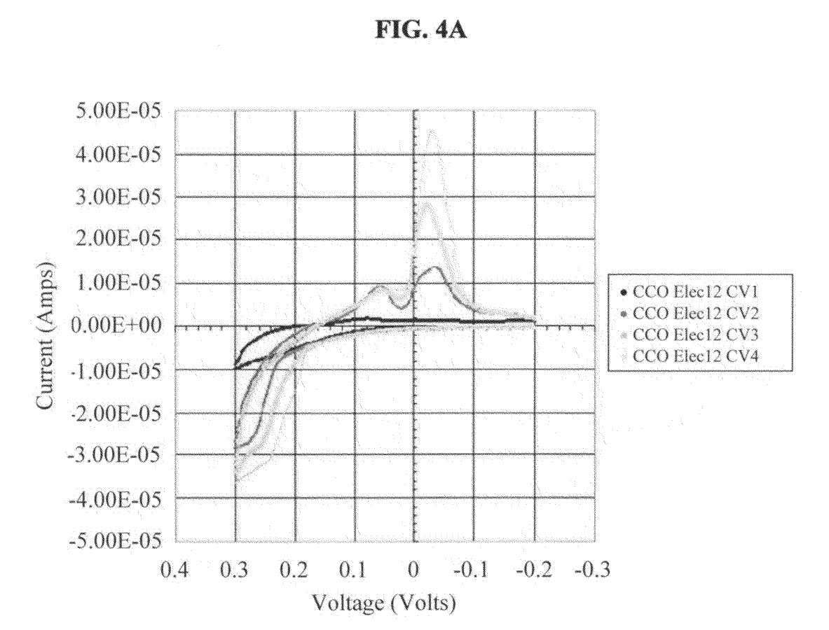

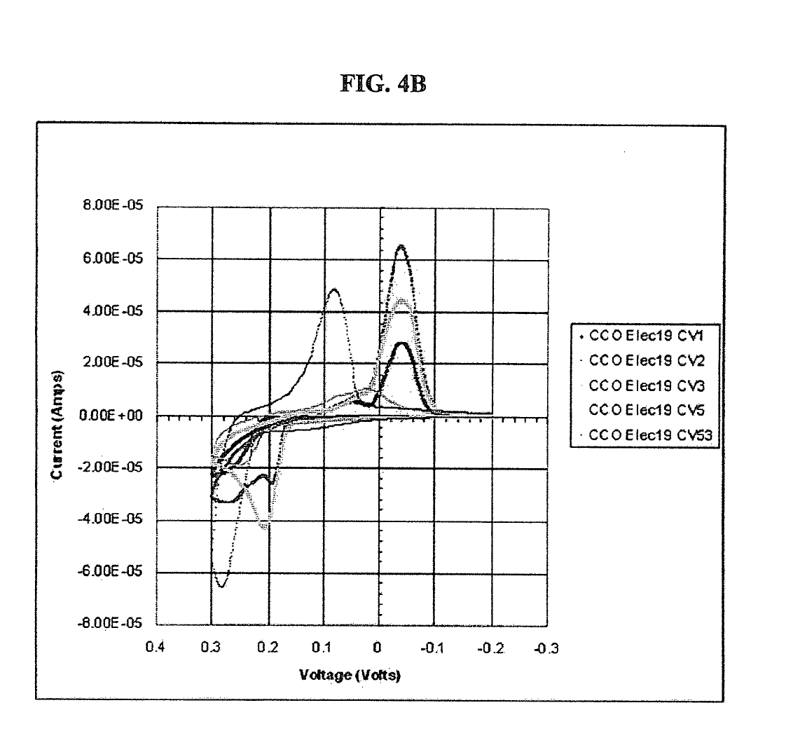

A source of contamination appeared in the cyclic voltammetry scans of the CCO electrode (FIGS. 4A & 4B). The peak shapes shifted in location and size, a second reduction peak occasionally appeared and the peaks were sometimes sharp even though the cyclic voltammetry parameters remained constant. Attempts were made to determine the source of contamination. For example, the dialysis cells, flow lines and fittings were cleaned thoroughly with detergent and ethanol and then rinsed with DI water; flow lines and fittings were replaced and a new dialysis cell was used; and glassware containing stock solutions were cleaned and all solutions were freshly prepared.

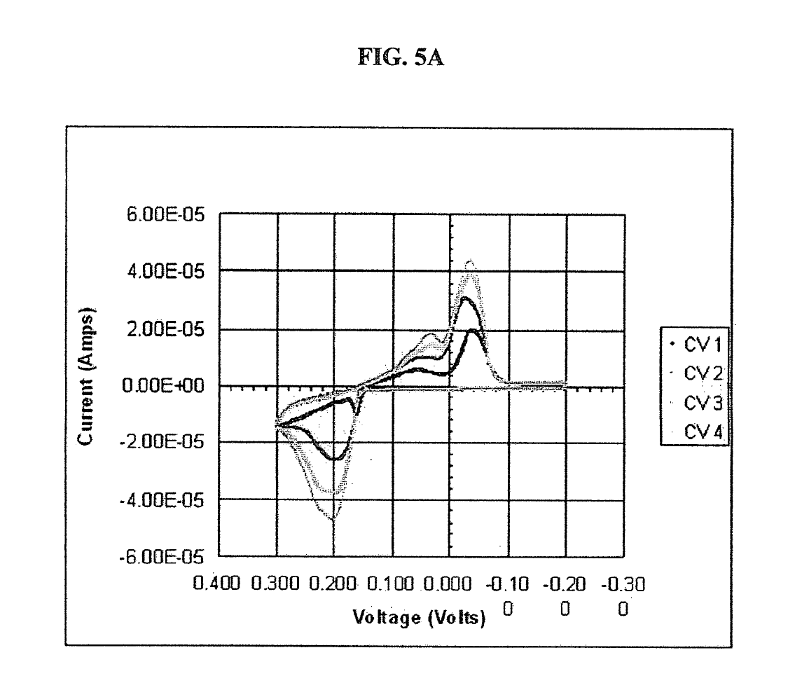

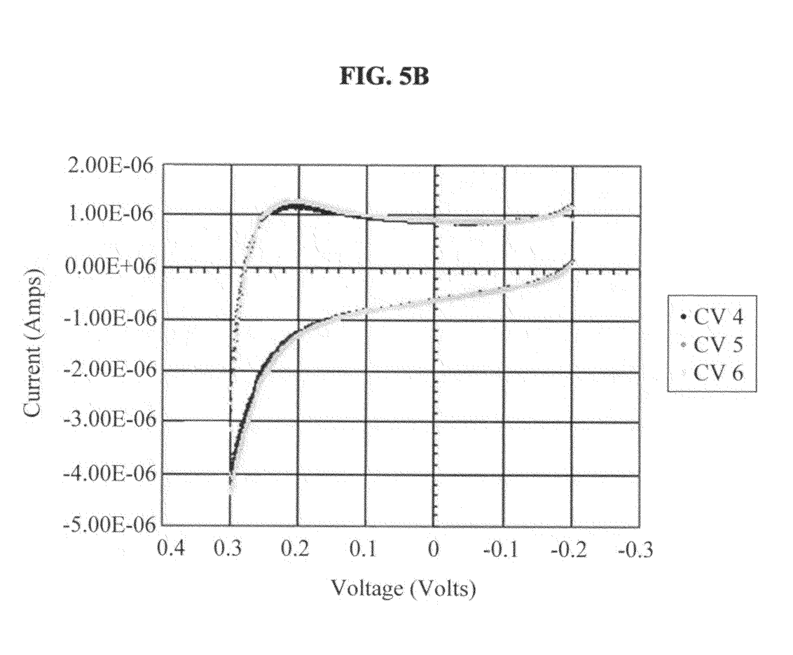

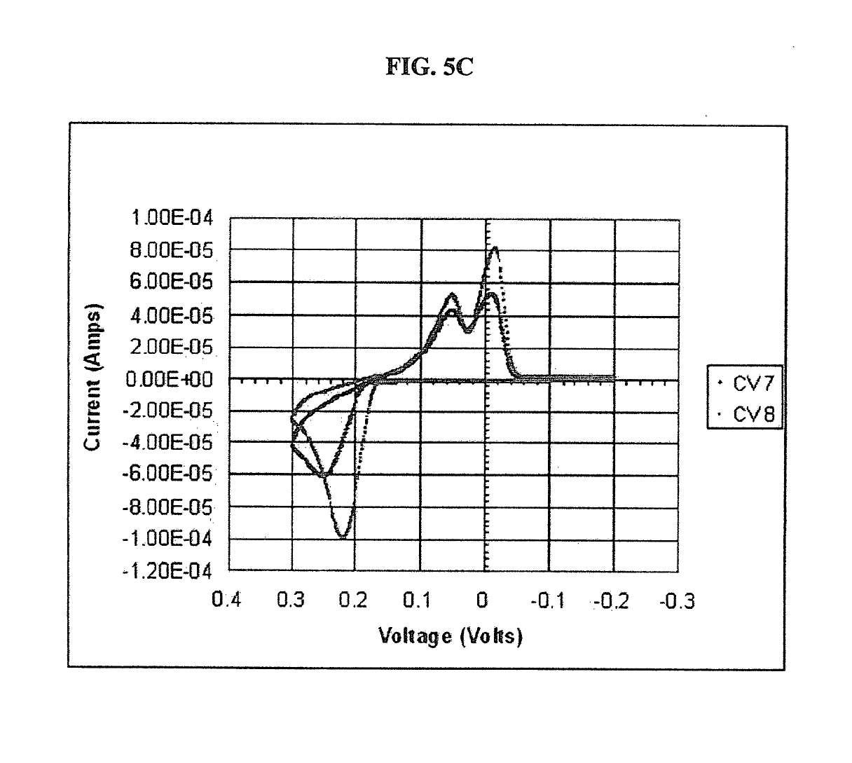

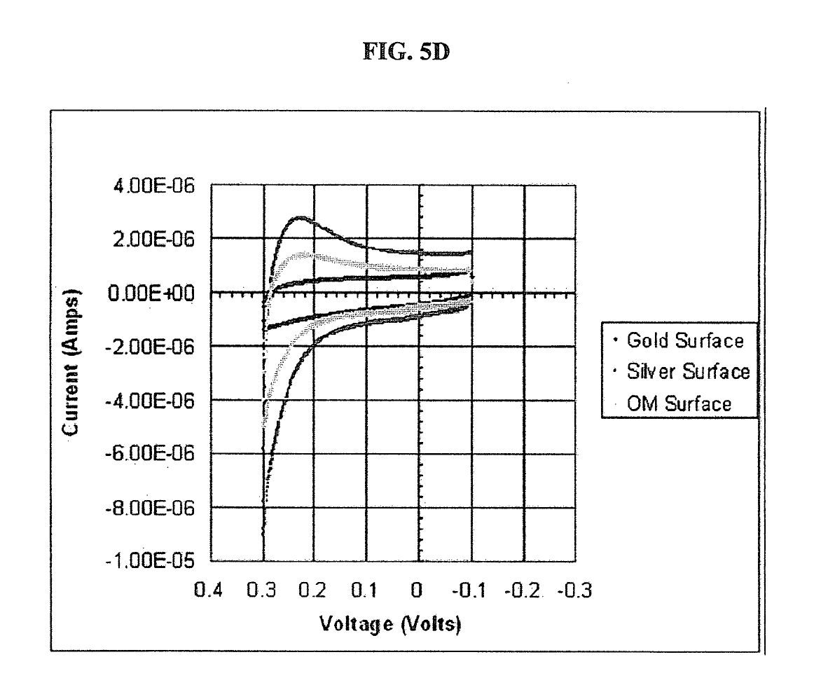

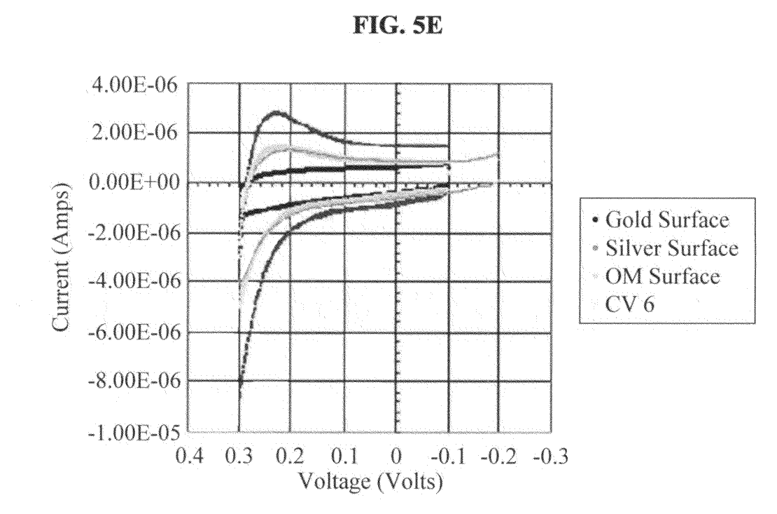

After the initial attempts to eliminate the source of contamination in CCO cyclic voltammograms failed, a blank lipid electrode was prepared to see if peaks would be present. The peaks found indicated that either the lipids were highly contaminated or chloride from the reference electrode was reacting with the silver monolayer to form silver chloride (FIG. 5A). Since Chelex-100 resin was used to remove possible contaminants from the lipids, and the lipids had been remade several times according to Burgess et al., 1998, the reference electrode was examined as the source of interference. To do this a double junction electrode was used to examine the same electrode used in FIG. 5A where the outer reference contained 0.1 M, pH 7.4 phosphate buffer and the inner reference electrode contained 1 M KCl. The resulting cyclic voltammogram when a double junction electrode was used is illustrated in FIG. 5B. The peaks were eliminated, suggesting that chloride from the single junction reference electrode was reacting with silver in the potential window of the experiment. To double check this result the double junction reference electrode was removed, and a single reference electrode was again used. The interfering silver chloride peaks again appeared in the cyclic voltammogram, confirming this hypothesis (FIG. 5C). Surface characterization of the electrode surface before the addition of lipid or lipid and enzyme is illustrated in FIG. 5D. Cyclic voltammograms of the bare gold surface, the silver deposition and OM deposition suggest a clean surface for every electrode and deposition step that was characterized. The decrease in double layer capacitance is as expected for the ½ monolayer of OM. A cyclic voltammogram from FIG. 5B, CV6, a lipid only electrode, was compared to these surface characterizations in FIG. 5E. The capacitance of the lipid only electrode was approximately the same for the OM deposition, which suggests a poor blocking film or that the bilayer did not form on the surface at all. FIG. 5F is a combination of cyclic voltammograms from FIGS. 5A-5E for current scale comparison.

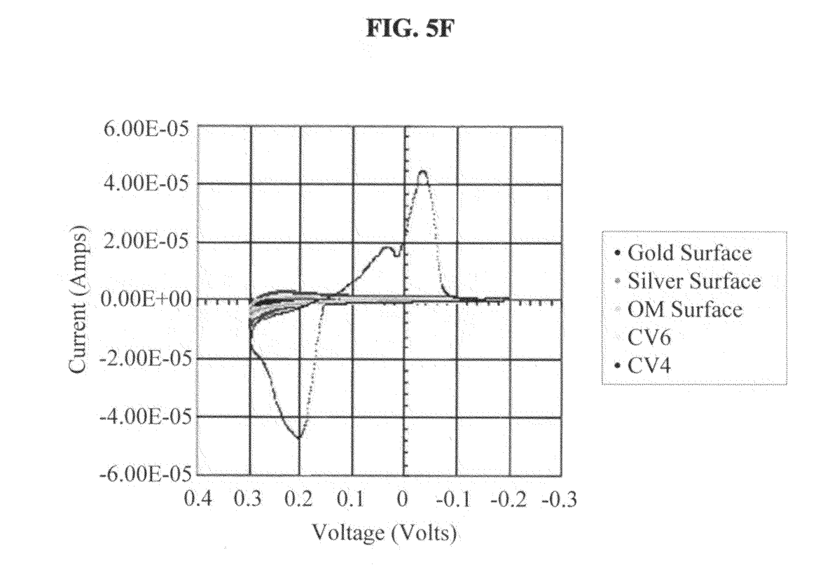

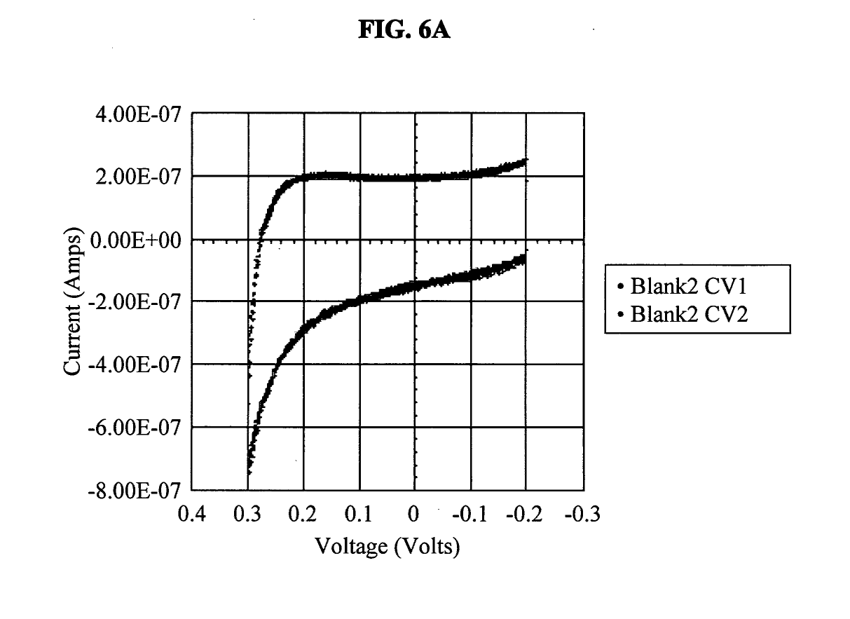

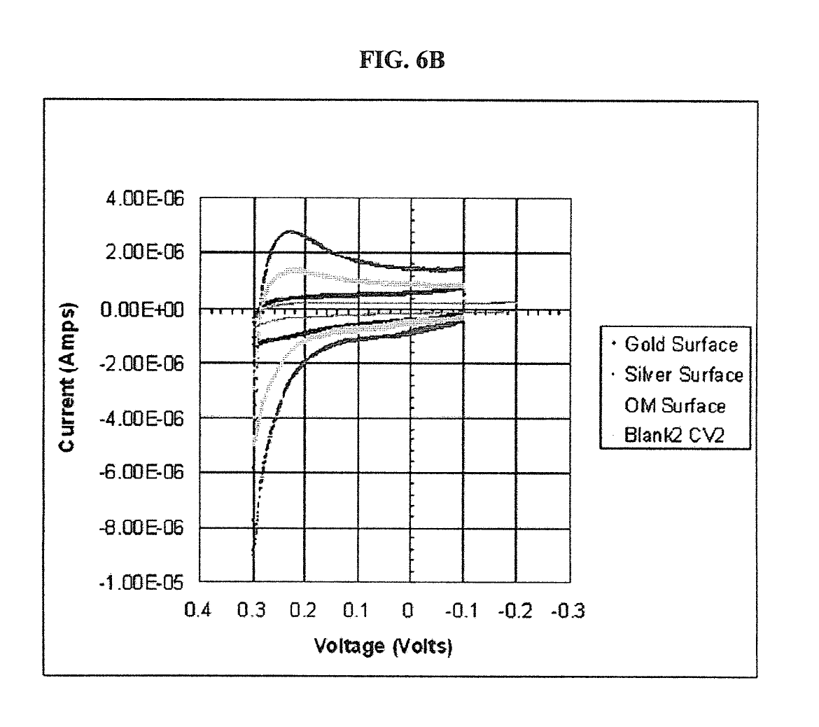

A new lipid-only electrode was then prepared in which the reference electrode did not contain 1M KCl and contained phosphate buffer during the bilayer formation. After the bilayer formation a double junction reference electrode as described earlier was also used in the cyclic voltammetry measurements. No silver chloride interference peaks were found (FIG. 6A). In addition a comparison of the double layer capacitance of the lipid bilayer and the double layer capacitance of the initial electrode surface characterizations showed a decrease, indicating a much better blocking film by the bilayer (FIG. 6B). Note, the gold surface characterization CV displayed in FIGS. 5D, 5E and 6B were performed in 0.1M KNO₃.

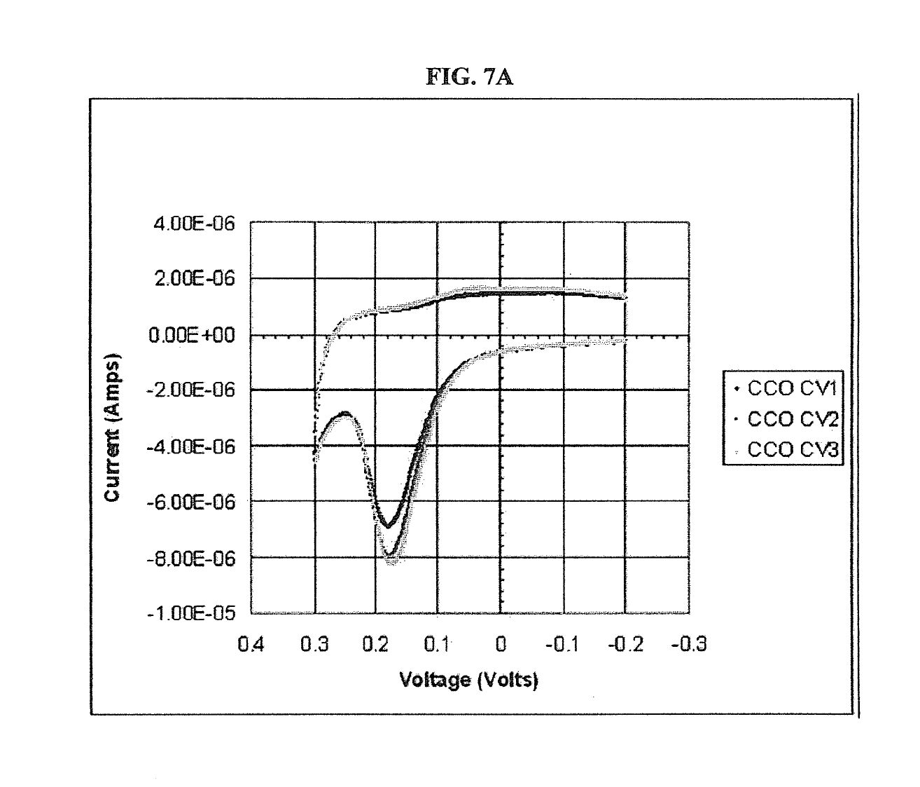

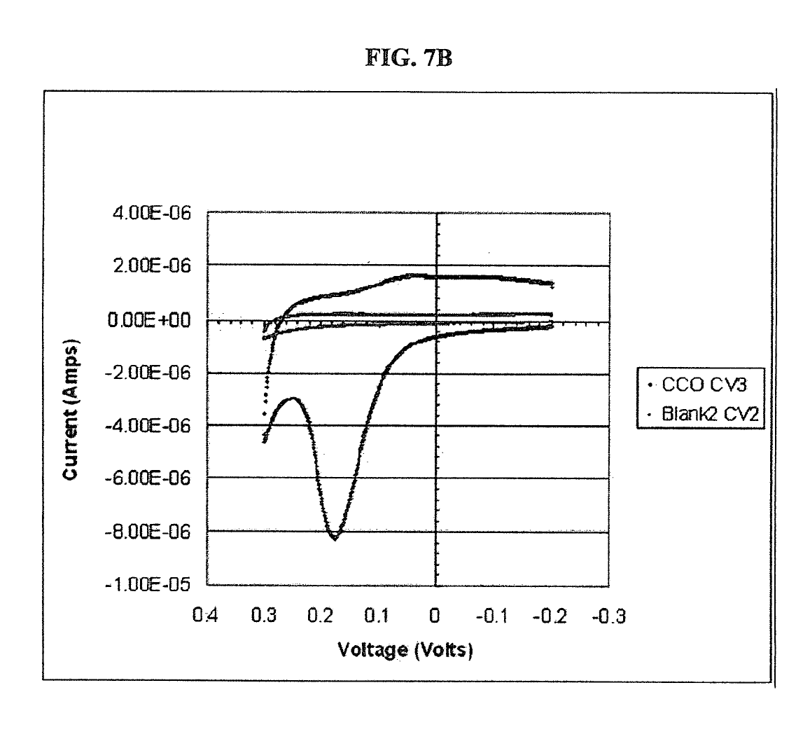

The same procedure described in removing possible silver chloride interference was applied to incorporation of CCO in the bilayer. The resulting cyclic voltammograms are much more stable and obtain an identical current response within 3 cyclic voltammograms (FIG. 7A). A comparison of the lipid only electrode and CCO electrode is illustrated in FIG. 7B and indicates that the voltammograms of CCO are more stable.

D. Spectroelectrochemistry Experimental Design

The dialysis cell was modified to hold a fiber optic probe that may be used to measure UV/visible changes of reduced cytochrome c (CCO's native redox partner) during its oxidation by CCO. After several rearrangements an experimental setup was established. The experimental setup was housed in a Yamato (South San Francisco, Calif.) DKN400 convectional oven, which is used to maintain constant temperatures and to help eliminate cyclic frequency noise in QCM measurements. The fiber optic probe is held in place by loctite epoxy in a threaded ¼ in ID Swagelok stainless steel fitting. In addition, it is advisable to put a thin layer coat of epoxy on the stainless steel probe casing to ensure the metal does not come in contact with the auxiliary electrode. Before the setup is applied to the oxidation of reduced cytochrome c by CCO the limitations and parameters for optimizing spectroscopic and electrochemical measurements should be obtained using a simpler redox couple and environment, such as the well-known ferri/ferro cyanide redox couple at a plain gold electrode.

E. Cytochrome c Oxidase Electrodes

Two observations should be considered when preparing a CCO modified electrode on silver. First, the OM deposition is much faster and appears to be more predictable when the electrode is not characterized with cyclic voltammetry using phosphate buffer after the preparations steps. Second, using a double junction reference electrode for electrochemical measurements and not having KCl in the reference electrode during the bilayer formation will eliminate possible chloride interference. There may be extremely small pinholes or cracks in the reference electrode that are not visible to the eye, which is probably the reason the silver chloride peaks were so large. These cracks or pinholes may form during the preparation of the reference electrode when heating the glass to seal around the frit. In addition the reference electrode frit itself is porous and will have a leak rate. However, single junction electrodes may be fine to use if the electrode frits have a small leak rate and the glass body is completely free of pinholes/cracks. Chloride interference may not be noticeable in these cases. Regardless of whether the reference electrode has a small leak rate or was made defect free, it is recommended that KCl be removed from the reference electrode when not in use and not placed in the reference electrode during bilayer formation.

### Example 2

### Detection of Cyanide Using Metmyoglobin

A. Preparing Stock Metmyoglobin Solutions

Horse heart myoglobin (Sigma-Aldrich, St. Louis, Mo.) was prepared by dissolving approximately 0.05 grams of myoglobin in 10 ml of 0.1 M phosphate buffer, pH 7.4 at room temperature. The sample was then filtered using Whatman No. 41 filter paper and stored at 4° C. when not in use. Further preparation of myoglobin was not necessary since all of the dissolved myoglobin is metmyoglobin. All dilutions from the stock Mb(III)H₂O were performed using 0.1M phosphate buffer, pH 7.4. The Mb(III)H₂O concentration was determined using Beer's Law. A=εbc, where ε is the molar absorptivity (M⁻¹ cm⁻¹), b is the pathlength (cm) and c is the molar concentration (M). The molar absorptivity for Mb(III)H₂O is 188,000 M⁻¹ cm⁻¹ at 409 nm (Anontini and Brunori, 1971). The cyanide solutions were prepared from sodium cyanide (Sigma-Aldrich. St. Louis, Mo.) in a basic solution of sodium hydroxide (Sigma-Aldrich, St. Louis, Mo.) to minimize loss of cyanide. Difference spectroscopy was applied since the absorbance spectrum for Mb(III)H₂O and Mb(III)CN⁻ overlap. The absorbance values at 409 nm are subtracted and applied to Beer's law in the difference form, dA=(dε)(db)(dc).

B. pH Effects

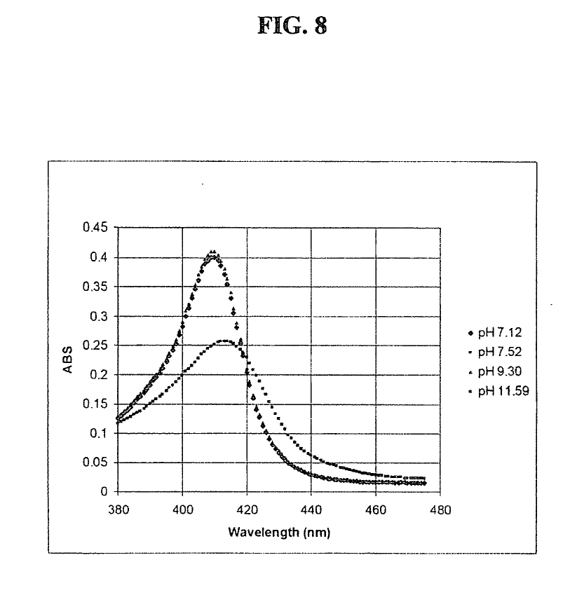

The effects of pH on Mb(III)H₂O absorption (ABS) were determined. The loss of cyanide from aqueous samples is often minimized by preserving samples with sodium hydroxide at a pH of greater than 9.3. For this reason the effects of different sodium hydroxide (NaOH) concentrations on Mb(III)H₂O absorption were determined. Aliquots of 200 μL of stock Mb(III)H₂O, in 0.1 M phosphate buffer, pH 7.4 were added to 0.5 mL cyanide standard samples in 0.1 M, 0.01 M, or 0.001 M NaOH to examine the effects of pH on Mb(III)H₂O absorption. Results are illustrated in FIG. 8 and Table 1 below.

TABLE 1

| | Amount of Well | NaOH Vol. | NaOH conc. | Final Sample |
|---|---|---|---|---|
| Sample | H₂O (mL) | Added (mL) | (Molar) | Measured pH |
| 1 | 10 | 0 | NA | 7.12 |
| 2 | 9 | 1 | 0.001 | 7.52 |
| 3 | 9 | 1 | 0.01 | 9.30 |
| 4 | 9 | 1 | 0.1 | 11.59 |

A final solution with a pH of 11.6 exhibited a significant decrease in absorbance. It was determined that cyanide standards should not be prepared in 0.1 M NaOH, and that the pH of the sample should be lower than 11.6. For the remaining determinations cyanide standard samples were prepared in either 0.01 M NaOH or 0.001 M NaOH to minimize release of cyanide to the atmosphere before testing and to minimize denaturing effects of Mb(III)H₂O at higher sample pH.

C. Isosbetic Point

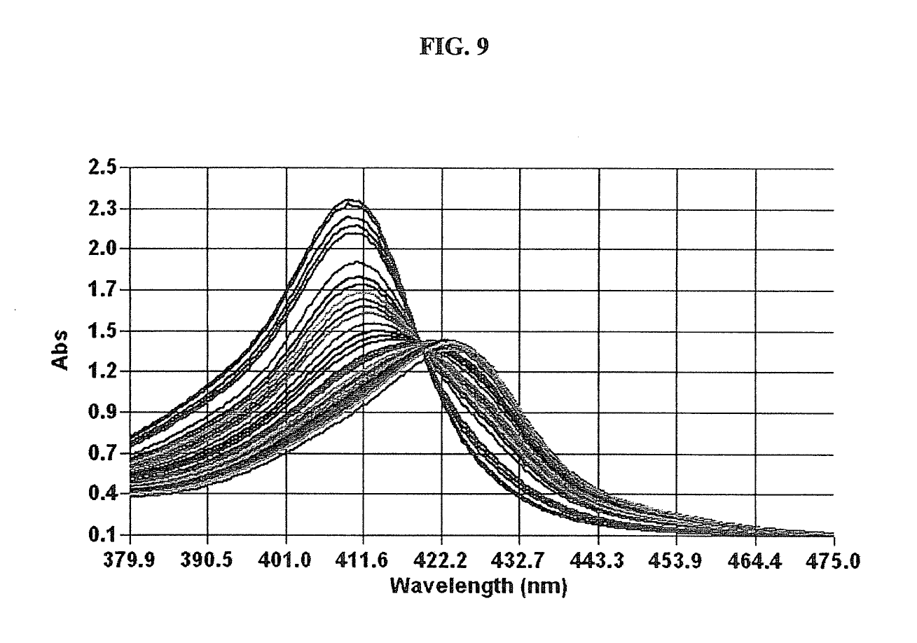

The presence of an isosbetic point demonstrates that Mb(III)H₂O and Mb(III)CN⁻ are interconvertible. Aliquots of 10 μl of 5 ppm CN⁻ in 0.01 M NaOH were added into a 1 cm cuvette containing 2.5 ml of Mb(III)H₂O dissolved in 0.1 M, pH 7.4 phosphate buffer. A total volume of 350 μl CN⁻ was added. Approximately 3 minutes after each aliquot, absorption was measured and recorded. FIG. 9 illustrates the isosbetic point, demonstrating that the absorbing forms of Mb(III)H₂O and Mb(III)CN⁻ are interconvertible.

D. Molar Absorptivity Determination

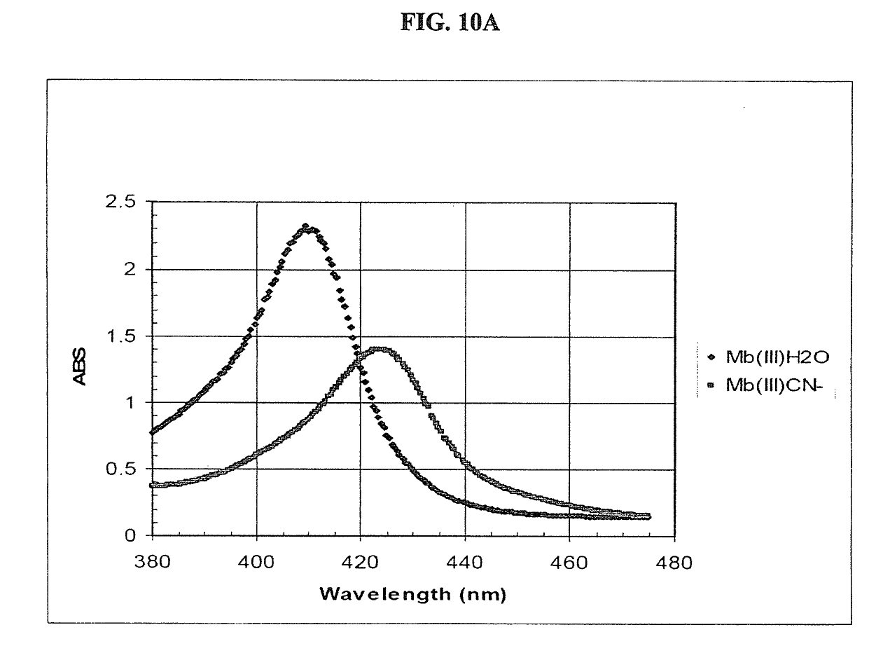

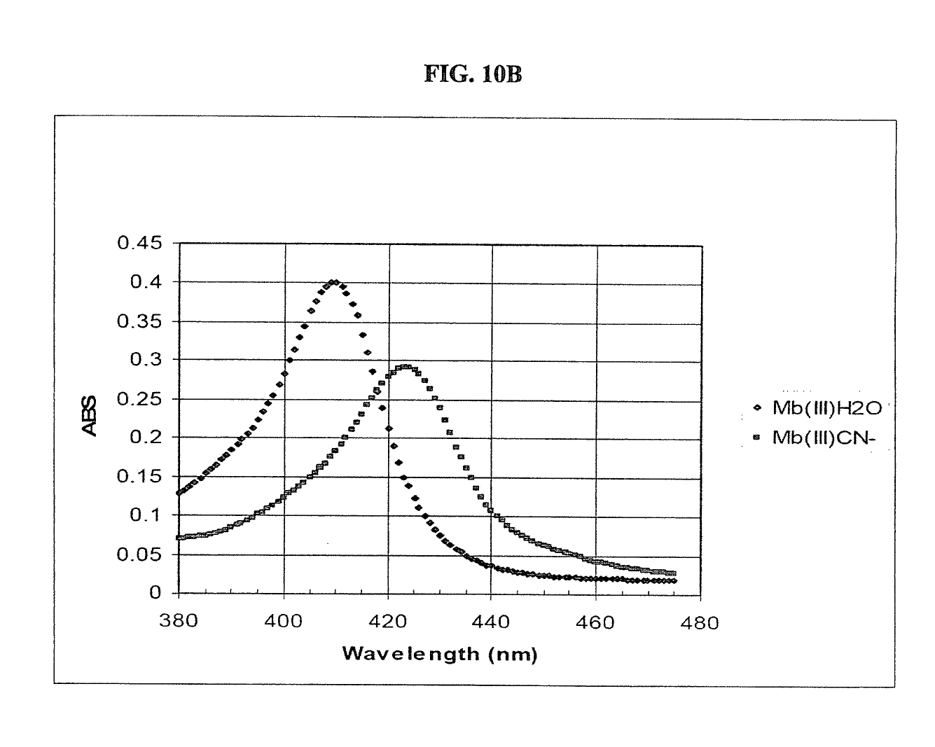

The molar absorptivity for Mb(III)CN⁻ was measured at 409 nm in two separate determinations. In the first determination 0.5 ml of 1 M NaCN in 0.01 M NaOH was added to 2.5 ml Mb(III)H₂O in 0.1 M, pH 7.4, phosphate buffer to ensure complete conversion to Mb(III)CN⁻. Using a molar absorptivity of 188,000 M⁻¹ cm⁻¹ at 409 nm for Mb(III)H₂O and a pathlength of 0.1 cm the concentration of Mb(III)H₂O was determined to be 12.2×10⁻⁶ M. After diluting to a Mb(III)H₂O concentration of 10.2×10⁻⁶ M, a molar absorptivity of about 82500 M⁻¹ cm⁻¹ at 409 nm for Mb(III)CN⁻ was calculated. The absorbance spectrum is plotted in FIG. 10A. In the second determination 200 μL of a Mb(III)H₂O stock solution in 0.1M, pH 7.4 phosphate buffer was added to 500 μL of sample, which had the constituents listed in Table 2 below:

TABLE 2

| | Well H₂O | Cyanide | Volume of 0.01M | Measured |
|---|---|---|---|---|
| | Volume | Concentration | NaOH added | ABS at |
| Samples | (mL) | (ppm) | (mL) | 409 nm |
| Sample 1 | 9 | 0 | 1 | 0.3998 |
| Sample 2 | 9 | 650 | 1 | 0.1748 |

Again using a molar absorptivity of 188,000 M⁻ cm⁻ at 409 nm the concentration of Mb(III)H₂O in sample 1 (without cyanide) was determined to be 21.2×10⁻⁶ M. Using this concentration a molar absorptivity of 82500 M⁻¹ cm⁻¹ at 409 nm for Mb(III)CN⁻ was also calculated. The absorbance (ABS) spectrum is plotted in FIG. 10B.

E. Detection of Cyanide

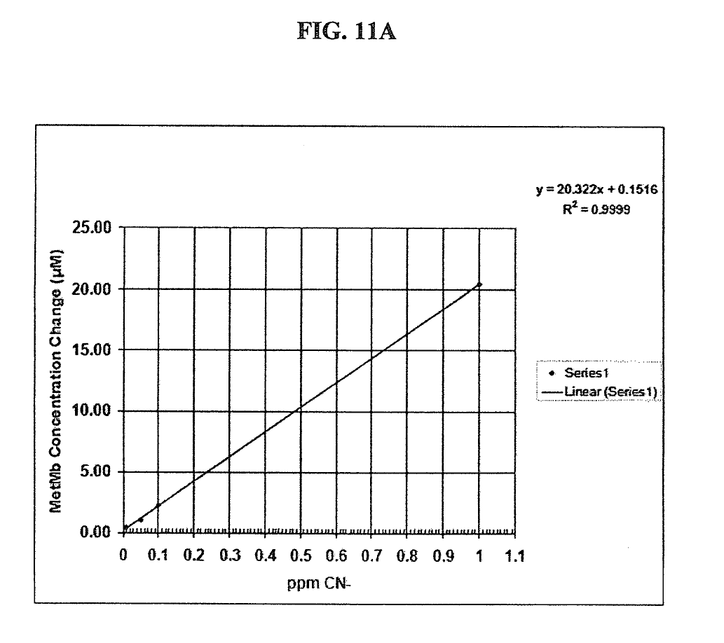

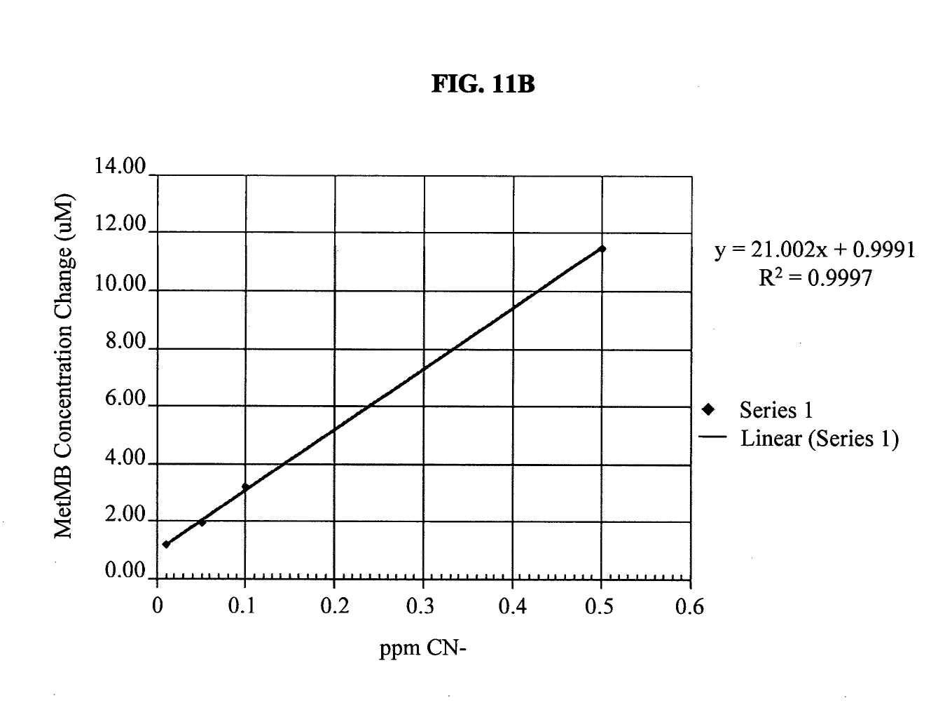

In the following experiments a series of cyanide standards were made and measured using Mb(III)H₂O. The change in concentration plotted versus the cyanide standards measured resulted in a linear calibration curve. In the first determination a series of standards were made in well water from a 10 ppm stock cyanide solution dissolved in 0.001 M NaOH. The pH of the blank sample was measured to be 7.6 using an Orion pH electrode. Using a 2 mL Teflon vial, 0.5 mL of the sample and 200 μL of stock Mb(III)H₂O were combined. A portion of the mixture was added to a 0.1 cm cuvette and the ABS was measured. Results are presented in Tables 3 and 4, and illustrated in FIG. 11A. Since the spectra for the two species overlap the absorbance values at 409 nm are subtracted and applied to Beer's law in the difference form, dA=(dε)(db)(dc).

TABLE 3

| | | Volume | Volume of 10 ppm |
|---|---|---|---|
| | Well Water | of 0.001M | CN (in 0.001M |
| Samples | Volume (mL) | NaOH added (μL) | NaOH) added (μL) |
| Blank | 9 | 1000 | 0 |
| 0.01 ppm CN | 9 | 990 | 10 |
| 0.05 ppm CN | 9 | 950 | 50 |
| 0.1 ppm CN | 9 | 900 | 100 |
| 1 ppm CN | 9 | 0 | 1000 |

TABLE 4

| | Measured | | | | |
|---|---|---|---|---|---|
| | ABS at | | | | |
| Samples | 409 nm | dA | dε | b | dC |
| Blank | 0.4605 | | | | |
| 0.01 ppm CN | 0.4559 | 0.0046 | 105500 | 0.1 | 4.36E−07 |
| 0.05 ppm CN | 0.4497 | 0.0108 | 105500 | 0.1 | 1.02E−06 |
| 0.1 ppm CN | 0.4368 | 0.0237 | 105500 | 0.1 | 2.25E−06 |
| 1 ppm CN | 0.2445 | 0.216 | 105500 | 0.1 | 2.05E−05 |

A second determination was conducted in which a series of standards were made in well water from a 5 ppm stock cyanide solution dissolved in 0.01 M NaOH. The pH of the blank sample was measured to be 9.4 using an Orion pH electrode. In a 2 mL Teflon vial 0.5 mL of the sample and 200 μL of stock Mb(III)H₂O were combined. A portion of mixture was added to a 0.1 cm cuvette and the ABS was measured. Results are illustrated Tables 5 and 6, and FIG. 11B.

TABLE 5

| | Well Water | | Volume of 5 ppm CN |
|---|---|---|---|
| | Volume | Volume of 0.01M | (in 0.01M NaOH) |
| Samples | (mL) | NaOH added (μL) | added (μL) |
| Blank | 9 | 1000 | 0 |
| 0.01 ppm CN | 9 | 980 | 20 |
| 0.05 ppm CN | 9 | 900 | 100 |
| 0.1 ppm CN | 9 | 800 | 200 |
| 0.5 ppm CN | 9 | 0 | 1000 |

TABLE 6

| | Measured | | | | |
|---|---|---|---|---|---|
| | ABS at | | | | |
| Samples | 409 nm | dA | dε | b | dC |
| Blank | 0.4169 | | | | |
| 0.01 ppm CN | 0.4042 | 0.0127 | 105500 | 0.1 | 1.20E−06 |
| 0.05 ppm CN | 0.3962 | 0.0207 | 105500 | 0.1 | 1.96E−06 |
| 0.1 ppm CN | 0.3831 | 0.0338 | 105500 | 0.1 | 3.20E−06 |
| 0.5 ppm CN | 0.2957 | 0.1212 | 105500 | 0.1 | 1.15E−05 |

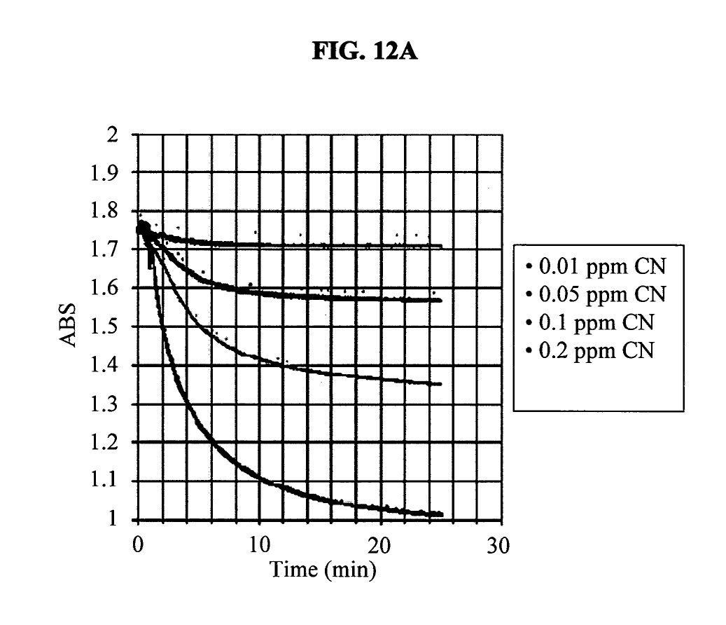

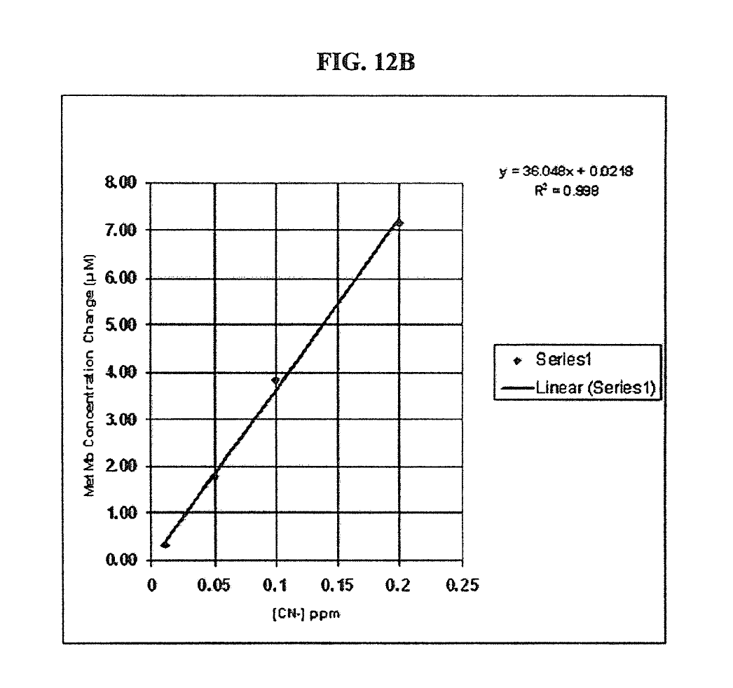

In a third determination, a series of cyanide standards were made so that when 10 μL were added to 2 ml of 9.2 μM Mb(III)H₂O in a 1 cm cuvette the concentration of cyanide would equal 0.01, 0.05, 0.1 and 0.2 ppm cyanide and would have the same concentration of NaOH added. The initial cyanide standards were prepared in 0.01 M NaOH. Approximately 0.5 minutes into the absorbance scan at 409 nm a 10 μL spike of the cyanide standard was added to give the desired ppm cyanide concentration. In this experiment the solution was not vortex mixed or stirred as in the previous experiments, and the cyanide was allowed to diffuse through the sample and bind to Mb(III)H₂O. Each reaction was allowed to proceed for 25 minutes (FIG. 12A). The absorbance was averaged from 24.5 to 25 minutes and then subtracted from the initial averaged absorbance from 0 to 0.5 min and plotted as the Mb(III)H₂O concentration change versus cyanide concentration (FIG. 12B). Results are presented in Table 7 below.

TABLE 7

| Sample | dA | dε | b | dC |
|---|---|---|---|---|
| 0.01 ppm CN | 0.0354 | 105500 | 1 | 3.353E−07 |
| 0.05 ppm CN | 0.1847 | 105500 | 1 | 1.751E−06 |
| 0.1 ppm CN | 0.4037 | 105500 | 1 | 3.826E−06 |
| 0.5 ppm CN | 0.7546 | 105500 | 1 | 7.152E−06 |

### Example 3

### Detection of Other Small Ligands Using Metmyoglobin

Other preferred small ligands that the invention may be used to detect include carbon monoxide, porphyrin, carbon disulfide, silane, phosphoric anhydride, imidazole, thiocyanate, azide, halogens or halides such as boride, fluoride, iodide, chloride, and astatide, and combinations thereof. Each of these small ligands have distinct absorbance wavelength spectra. When bound to metmyoglobin it is expected that the respective bound products also will have distinct absorbance wavelength spectra. As was demonstrated for cyanide, a spectrographic analysis and standard curve may be generated for each metmyoglobin binding small ligand to determine the most desirable wavelength for detection and to calibrate for concentration. The spectrographic analysis will be similar but unique for each small ligand toxin and may be used to identify a particular small ligand toxin in a sample where the identity of the toxin is unknown. In addition the standard curve may be used to quantitate levels of a small ligand toxins in a sample as described above for cyanide.

A. Molar Absorptivity Determination of Metmyoglobin Binding Small Ligands

The molar absorptivity for Mb(III)SL⁻ may be determined as previously described for Mb(III)CN⁻. For example, an aliquot of 0.5 ml of 1 M SL in 0.01 M NaOH, or an appropriate aqueous solvent, may be added to 2.5 ml Mb(III)H₂O in 0.1 M, phosphate buffer at pH 7.4. The reaction may then be allowed to continued to ensure the complete conversion of Mb(III)H₂O to Mb(III)SL⁻. Using a molar absorptivity of 188,000 M-1 cm-1 at 409 nm for Mb(III)H₂O and a pathlength of 0.1 cm, the concentration of Mb(III)H₂O may be determined. This concentration will correspond to the concentration of Mb(III)SL⁻ after the complete reaction and can be used to calculate the molar absorptivity of Mb(III)SL⁻ for a SL sample at 409 nm. Certain conditions such as optimum pH, temperature, or incubation time may vary depending on the particular SL, but may easily be tested and controlled for within acceptable ranges. An absorbance spectrum may be determined and yield results similar to those illustrated in FIG. 10A.

In another method of determination, 200 μL of Mb(III)H₂O stock solution in 0.1M, pH7.4 phosphate buffer may be added to 500 μL of SL sample, with the constituents shown Table 8 below.

TABLE 8

| | | | Volume |
|---|---|---|---|
| | Well H₂O Volume | SLT Concentration | of 0.01M NaOH |
| Samples | (mL) | (ppm) | added (mL) |
| Sample 1 | 9 | 0 | 1 |
| Sample 2 | 9 | 650 | 1 |

Again using a molar absorptivity of 188,000 M⁻¹ cm⁻¹ at 409 nm, the concentration of Mb(III)H₂O in sample 1 (without SL) may be determined. Upon completion of the reaction this concentration will correspond to the concentration of Mb(III)SL⁻. Molar absorptivity at 409 nm for each the Mb(III)SL⁻ tested may be calculated. An absorptivity spectrum may be plotted in a manner similar to that illustrated in FIG. 10B.

B. Detection of Small Ligands:

A series of SL standards may be made and combined with Mb(III)H₂O. The change in concentration plotted versus SL standard concentrations is expected to result in a linear calibration curve useful in quantitating unknown amounts of SL. A series of standards may be made in water from, for example, a 10 ppm stock solution dissolved in 0.001 M NaOH or an appropriate aqueous solvent. The pH of the blank sample may be adjusted to be 7.6. In a 2 mL Teflon vial, 0.5 mL of the sample and 200 μL of stock Mb(III)H₂O may be combined. A portion of the mixture can be added to a 0.1 cm cuvette and the ABS measured. Since the spectra for the two species may overlap the absorbance values at 409 nm may be subtracted and applied to Beer's law in the difference form, dA=(dε)(db)(dc).

Another determination may be conducted in which a series of standards are made in water from a 5 ppm stock SL solution dissolved in 0.01 M NaOH or an appropriate aqueous solvent. The pH of the blank sample may be measured and adjusted if greater than 9.6. In a 2 mL Teflon vial, 0.5 mL of the sample and 200 μL of stock Mb(III)H₂O may be combined. A portion of sample can be added to a 0.1 cm cuvette and the ABS measured.

A series of SL standards may be made so that when 10 μL are added to 2 ml of 9.2 μM Mb(III)H²O in a 1 cm cuvette the concentration will equal 0.01, 0.05, 0.1 and 0.2 ppm SL with equivalent amounts of NaOH or aqueous solvent added. Approximately 0.5 minutes into the absorbance scan at 409 nm a 10 μL spike of SL. standard can be added to give the desired ppm SL concentration. The solution need not be mixed and the SL can be allowed to diffuse through the sample and bind to Mb(III)H₂O. Each reaction can be allowed to proceed for 25 minutes similar to that demonstrated for cyanide as in FIG. 12A. The absorbance can be averaged at a time from 24.5 to 25 minutes and then subtracted from the initial averaged absorbance at a time of 0 to 0.5 min, and plotted as Mb(III)H₂O concentration change versus SL concentration similar to that demonstrated for cyanide in FIG. 12B.

As a result, the absorbance spectrum characteristic of the presence of a small ligand of interest, such as carbon monooxide or azide, can be determined and used to detect its presence in relatively small concentrations in a sample of unknown composition with the invention.

### Example 4

### Noninvasive Detection of Small Ligand Exposure in Individuals

If it is suspected that an individual has been exposed to an unknown toxin(s), it is imperative that the identity of the unknown toxin(s) be ascertained as quickly as possible. In either a combat or other hazardous situation, transport to a medical facility may not be immediately available. Further, treatment for exposure to one toxin may be contraindicated for the treatment of a different toxin. Thus, the identity of the toxin(s) is highly desirable. The absorbance of Mb(III)SL⁻ can be detected outside of the container of the physical sample. This feature may be exploited to hasten the detection of exposure to various toxins in individuals through non-invasive methods.

Specifically, because the small ligands of the invention readily bind to the heme in metmyoglobin, these small ligands will also readily bind to the home in methemoglobin. As such, a spectrometric device should be able to detect the presence of a small ligand bound to methemoglobin when its sensor is pressed against the skin over a pulse point where the blood flow is near the surface of the skin. Exemplary pulse points include: the ventral aspect of the wrist on the side of the thumb (radial artery), the neck (carotid artery), the inside of the elbow, or under the biceps muscle (brachial artery), the groin, behind the medial malleolus on the feet (posterior tibial artery) the middle of dorsum of the foot (dorsalis pedis), behind the knee (popliteal artery), and over the abdomen (abdominal aorta).

In this manner, an individual may be quickly checked for exposure to a variety of toxic, small ligands by simply adjusting the spectrometric device to various wavelengths. Those of skill in the art will readily recognize that this method is not limited to humans and may be used to quickly screen animals that may have been exposed to one or more toxic small ligands. An advantage of this method is that it is non-invasive, rapid, and can check for multiple small ligands. The animals being checked may be pets or part of the food industry.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the following claims.

### REFERENCES

The following references, to the extent that they provide exemplary procedural or other details supplementary to those set forth herein, are specifically incorporated herein by reference. All patents and publications referred to herein are incorporated by reference.
1. Burgess, J. D.; Hawkridge, F. M., Octadecyl Mercaptan sub-monolayers on silver electrodeposited on gold quartz crystal microbalance electrodes. Langmuir 1997, 13, 3781-3786.
2. Burgess, J. D.; Rhoten, M. C.; Hawkridge, F. M., Cytochrome c Oxidase immobilized instable supported lipid bilayer membranes. Langmuir 1998, 14, 2467-2475.
3. Cullison, J. K., Hawkridge, F. M., Nakashima, N, Yoshikawa, S., A study of Cytochrome c Oxidase in lipid bilayer membranes on electrode surfaces. Langmuir 1994, 10, 877-882.
4. Soulimane, T.; Buse, G. Integral Cytochrome c Oxidase: Preparation and progress towards a three dimensional crystallization. Eur. J. Biochem. 1995, 227, 588-595.
5. Hinkle, P. C.; Kim, J. J.; Racker, E., Ion transport and respiratory control in vesicles formed from cytochrome oxidase and phospholipids. J. Biol. Chem. 1972, 247, 1338.
6. Tsukihara, T., Aoyama, H. Yamashita, E., Tomizaki, T., Yamaguchi, H., Shinzawa-Itoh, K., Nakashima, R., Yaono, R., Yoshikawa, S., Structure of metal sites of oxidized bovine heart cytochrome c oxidase at 2.8 Å resolution, Science, 1995, 269, 1069-1074.
7. Tsukihara, T., Aoyama, H. Yamashita, E., Tomizaki, T., Yamaguchi, H., Shinzawa-Itoh, K., Nakashima, R., Yaono, R., Yoshikawa, S., The whole structure of the 13 subunit oxidized cytochrome c oxidase at 2.8 Å, Science, 1996, 272, 1136-1144.
8. Bates, R. G., Determination of pH: Theory and Practice. In John Wiley & Sons New York, 1985; p 299.
9. Bruckenstein, S.; Shay, M., Experimental aspects of use of the quartz crystal microbalance in solution. Electrochim. Acta 1985, 30, 1295-1300.
10. Sauerbrey, G., The use of quartz oscillators for weighing thin layers and for microweighing. Phys. Z. 1959, 155, 206-222.
11. Gelder, B. F. V.; Slater, E. C., The extinction coefficient of cytochrome c. Biochim. Biophys. Acta 1962, 58, 593-595.
12. Margoliash, E.; Schejter, A., Cytochrome c. Adv. Protein Chem. 1966, 21, 113-286.
13. Bruckenstein, S.; Michaliski, M.; Fensore, A.; Li, Z.; A. R. Hillman, Dual quartz crystal microbalance oscillator circuit. Minimizing effects due to liquid viscosity, density, and temperature. Anal. Chem. 1994, 66, 1847-1852.
14. Anontini, E. and Brunori, M., Hemoglobin and myoglobin in their reactions with ligands. In Frontiers of Biology, North-Holland: Amsterdam, 1971, vol. 21.
15. Wittenberg, B. A., Wittenberg, J. B., Myoglobin-mediated oxygen delivery to mitochondria of isolated cardiac myocytes. PNAS USA 1987, 84, 7503-7507.
16. Edmundson, A. B., Hirs, C. H. W., J. Mol. Biol. 1962, 5, 663-682.
17. Wittenberg, B. A., Wittenberg, J. B., Role of myoglobin in the oxygen supply to red skeletal muscle. J. Mol. Biol. 1975, 250, 9038-9043.
18. King. B. C. Hawkridge, F. M., Hoffman, B. M., Electrochemical studies of cyanometmyoglobin and metmyoglobin: implications for long-range electron transfer in proteins. J. Am. Chem. Soc. 1992, 114, 10603-10608.
19. Anontini, E., Brunori, M., Hemoglobin and myoglobin in their reactions with ligands. In Frontiers of Biology, North-Holland: Amsterdam, 1971: vol. 21.

We claim:

1. A method of detecting a small ligand, with the method comprising:
a. contacting metmyoglobin and a sample suspected of containing a small ligand selected from the group consisting of cyanide, carbon monoxide, porphyrin, carbon disulfide, silane, phosphoric anhydride, imidazole, thiocyanate, azide, halogens or halides such as boride, fluoride, iodide, chloride, and astatide, and combinations thereof; and,
b. detecting the small ligand bound to the metmyoglobin with a portable device, wherein the portable device is a test strip.

2. The method of claim 1, wherein the metmyoglobin is in an aqueous solution.

3. The method of claim 1, wherein the metmyoglobin is attached to or incorporated into a solid surface selected from the group consisting of a metallic nanoparticle, nonmetallic nanoparticle, electrode, metal, cellulose, polymer, plastic, gel, cloth, and any combination thereof.

4. The method of claim 1, wherein the sample is a biological fluid.

5. The method of claim 1, wherein the sample is a nonbiological sample.

6. The method of claim 1, wherein the portable device is selected from the group consisting of a portable colorimeter, a test strip, a color chart, and combinations thereof.

7. The method of claim 1, wherein the detection limit is about 10 parts per trillion.

8. The method of claim 7, wherein the detection limit is about 100 parts per trillion.

9. The method of claim 8, wherein the detection limit is about 1 part per billion.

10. The method of claim 9, wherein the detection limit is about 10 parts per billion.

11. A kit for detecting a small ligand, with the kit comprising:
a. metmyoglobin;
b. a container suitable for combining metmyoglobin and a sample suspected of containing a small ligand selected from the group consisting of cyanide, carbon monoxide, porphyrin, carbon disulfide, silane, phosphoric anhydride, imidazole, thiocyanate, azide, halogens or halides such as boride, fluoride, iodide, chloride, and astatide, and combinations thereof; and
c. a portable device for detecting a small ligand bound to metmyoglobin, wherein the device is a test strip.

12. The kit of claim 11, wherein the metmyoglobin is in an aqueous solution.

13. The kit of claim 11, wherein the metmyoglobin is attached to or incorporated into a solid surface selected from the group consisting of a metallic nanoparticle, nonmetallic nanoparticle, electrode, metal, cellulose, glass, polymer, plastic, gel, cloth, and any combination thereof.

14. The kit of claim 11, further comprising an aqueous solution.

15. The kit of claim 11, wherein the device is selected from the group consisting of a portable colorimeter, a test strip, a color chart, and combinations thereof.

16. The kit of claim 11, wherein container is selected from the group consisting of a cuvette, vacutube, test tube, plastic tube, and glass tube.

17. The kit of claim 11, wherein the sample is a biological fluid.

18. The kit of claim 11, wherein the sample is a nonbiological sample.

19. The kit of claim 11, wherein the small ligand is detected in a concentration of about 10 parts per billion or less.

20. The kit of claim 19, wherein the small ligand is detected in a concentration of about 1 part per billion or less.

21. The kit of claim 20, wherein the small ligand is detected in a concentration of about 100 parts per trillion or less.
